(19) United States
(12) Patent Application Publication
(10) Pub. No.: US 2026/0341075 A1
(43) Pub. Date: Oct. 29, 2026

(54) BIOMETRIC RECOGNITION

(71) Applicant: Tencent Technology (Shenzhen) Company Limited, Shenzhen (CN)

(72) Inventors: Weiming YANG, Shenzhen (CN); Runzeng GUO, Shenzhen (CN); Shaoming WANG, Shenzhen (CN); Jun WANG, Shenzhen (CN); Jinkun HOU, Shenzhen (CN)

(73) Assignee: Tencent Technology (Shenzhen) Company Limited, Shenzhen (CN)

(21) Appl. No.: 19/681,020

(22) Filed: May 18, 2026

Related U.S. Application Data
(63) Continuation of application No. PCT/CN2024/121294, filed on Sep. 26, 2024.

(30) Foreign Application Priority Data
Mar. 7, 2024 (CN) 202410263657.0

(51) Int. Cl. G06V 40/12; G06V 10/60; G06V 10/75; G06V 10/77; G06V 40/20

(52) U.S. Cl. CPC G06V 40/1365; G06V 40/1347; G06V 10/60; G06V 10/751; G06V 10/7715; G06V 40/20

(57) ABSTRACT

In a biometric recognition method, a first image is acquired based on a first exposure parameter, and a first recognition region in the first image is determined. In the method, a second exposure parameter is obtained based on adjusting the first exposure parameter when a brightness level of the first recognition region does not fall within a reference brightness range. In the method, a second image is acquired based on the second exposure parameter. In the method, when a brightness level of a second recognition region falls within the reference brightness range, an object associated with the biometric characteristic within the second recognition region is recognized. Apparatus and non-transitory computer-readable storage medium counterparts are also described.

### RELATED APPLICATIONS

The present application is a continuation of International Application No. PCT/CN2024/121294, filed on Sep. 26, 2024, which claims priority to Chinese Patent Application No. 202410263657.0, filed on Mar. 7, 2024, and entitled “BIOMETRIC RECOGNITION METHOD AND APPARATUS, COMPUTER DEVICE, AND STORAGE MEDIUM.” The entire disclosures of the prior applications are hereby incorporated by reference.

### FIELD OF THE TECHNOLOGY

Embodiments of this disclosure relate to the field of computer technologies, including biometric recognition methods and apparatuses, computer devices, and non-transitory computer-readable storage media.

### BACKGROUND

With the development of computer technologies, biometric recognition technologies are increasingly widely applied, and can be applied to a plurality of scenarios. For example, in a payment scenario or an attendance-recording scenario, a user identity can be authenticated through biometric recognition. In some applications, a biometric recognition process may include, when an image including a biometric characteristic is acquired, biometric recognition is performed on the image, to recognize an object to which the biometric characteristic included in the image belongs.

### SUMMARY

Embodiments of this disclosure provide biometric recognition methods and apparatuses, computer devices, and non-transitory computer-readable storage media, to improve accuracy and a success rate of biometric recognition. The technical solutions are follows:

According to an aspect, a biometric recognition method is provided. In the method, a first image is acquired based on a first exposure parameter, and a first recognition region in the first image is determined, the first recognition region including a biometric characteristic. In the method, a second exposure parameter is obtained by processing circuitry based on adjusting the first exposure parameter when a brightness level of the first recognition region does not fall within a reference brightness range. In the method, a second image is acquired based on the second exposure parameter, the second image including the biometric characteristic. In the method, motion information indicating a change of a position of the biometric characteristic in the second image relative to the first image is determined by the processing circuitry. In the method, a second recognition region in the second image is determined based on the motion information, the second recognition region including the biometric characteristic. In the method, when a brightness level of the second recognition region falls within the reference brightness range, an object associated with the biometric characteristic included in the second recognition region is recognized.

According to another aspect, a biometric recognition apparatus is provided. The apparatus includes processing circuitry configured to acquire a first image based on a first exposure parameter. The processing circuitry is configured to determine a first recognition region in the first image, the first recognition region including a biometric characteristic. The processing circuitry is configured to obtain a second exposure parameter based on adjusting the first exposure parameter when a brightness level of the first recognition region does not fall within a reference brightness range. The processing circuitry is configured to acquire a second image based on the second exposure parameter, the second image including the biometric characteristic. The processing circuitry is configured to determine motion information indicating a change of a position of the biometric characteristic in the second image relative to the first image. The processing circuitry is configured to determine a second recognition region in the second image based on the motion information, the second recognition region including the biometric characteristic. The processing circuitry is configured to recognize, when a brightness level of the second recognition region falls within the reference brightness range, an object associated with the biometric characteristic included in the second recognition region.

According to another aspect, a non-transitory computer-readable storage medium is provided. The non-transitory computer-readable storage medium stores instructions, which when executed by a processor, cause the processor to perform a biometric recognition method. In the method, a first image is acquired based on a first exposure parameter, and a first recognition region in the first image is determined, the first recognition region including a biometric characteristic. In the method, a second exposure parameter is obtained based on adjusting the first exposure parameter when a brightness level of the first recognition region does not fall within a reference brightness range. In the method, a second image is acquired based on the second exposure parameter, the second image including the biometric characteristic. In the method, motion information indicating a change of a position of the biometric characteristic in the second image relative to the first image is determined. In the method, a second recognition region in the second image is determined based on the motion information, the second recognition region including the biometric characteristic. In the method, when a brightness level of the second recognition region falls within the reference brightness range, an object associated with the biometric characteristic included in the second recognition region is associated.

According to an aspect, a biometric recognition method is provided. The method is performed by a computer device, and the method includes: determining a first recognition region from a first image, an image within the first recognition region including a biometric characteristic, and the first image being acquired based on a first exposure parameter; adjusting the first exposure parameter when a brightness level of the image within the first recognition region does not fall within a reference brightness range, to obtain a second exposure parameter; acquiring a second image based on the second exposure parameter, the second image including the biometric characteristic; determining a second recognition region from the second image, an image within the second recognition region including the biometric characteristic; and recognizing, when a brightness level of the image within the second recognition region falls within the reference brightness range, an object to which the biometric characteristic included in the image within the second recognition region belongs.

According to another aspect, a biometric recognition apparatus is provided. The apparatus includes: a determining module, configured to determine a first recognition region from a first image, an image within the first recognition region including a biometric characteristic, and the first image being acquired based on a first exposure parameter; an adjustment module, configured to adjust the first exposure parameter when a brightness level of the image within the first recognition region does not fall within a reference brightness range, to obtain a second exposure parameter; an acquisition module, configured to acquire a second image based on the second exposure parameter, the second image including the biometric characteristic, the determining module being further configured to determine a second recognition region from the second image, an image within the second recognition region including the biometric characteristic; and a recognition module, configured to recognize, when a brightness level of the image within the second recognition region falls within the reference brightness range, an object to which the biometric characteristic included in the image within the second recognition region belongs.

According to another aspect, a computer device is provided. The computer device includes processing circuitry (e.g., a processor) and a memory (e.g., including a non-transitory computer-readable storage medium), the memory having at least one computer program stored therein, the at least one computer program being loaded and executed by the processor, to cause the computer device to implement the operations performed in the biometric recognition method according to one or more aspects in this disclosure.

According to another aspect, a non-transitory computer-readable storage medium is provided. The non-transitory computer-readable storage medium has at least one computer program stored therein, the at least one computer program being loaded and executed by processing circuitry (e.g., a processor), to cause a computer to implement the operations performed in the biometric recognition method according to one or more aspects in this disclosure.

According to still another aspect, a computer program product is provided, including a computer program, the computer program being executed by processing circuitry (e.g., a processor), to cause a computer to implement the operations performed in the biometric recognition method according to one or more aspects in this disclosure.

According to one or more solutions provided in this disclosure, during biometric recognition, a first recognition region is determined from an acquired first image, to determine a position of a biometric characteristic in the first image. It is detected whether a brightness level of an image within the first recognition region is sufficient, to determine whether the biometric characteristic in the first image is sufficiently clear. When the brightness level of the image within the first recognition region does not fall within a reference brightness range, it is determined that the biometric characteristic in the first image is not sufficiently clear, and an exposure parameter is adjusted, to acquire a next image (that is, a second image) by using the adjusted exposure parameter, so that definition of the biometric characteristic in the acquired next image is improved. When a brightness level of an image (that is, an image including the biometric characteristic) within a second recognition region in the second image falls within the reference brightness range, the biometric characteristic in the second image is sufficiently clear. In this case, biometric recognition is performed on the image within the second recognition region to recognize a biometric characteristic of which object the biometric characteristic is, so that a recognition error or a recognition failure caused by an unclear biometric characteristic in the image can be reduced, thereby improving accuracy and a success rate of biometric recognition.

### BRIEF DESCRIPTION OF THE DRAWINGS

FIG. 1 is a schematic structural diagram of an implementation environment according to an embodiment of this disclosure.

FIG. 2 is a flowchart of a biometric recognition method according to an embodiment of this disclosure.

FIG. 3 is a flowchart of another biometric recognition method according to an embodiment of this disclosure.

FIG. 4 is a schematic structural diagram of a camera acquisition device according to an embodiment of this disclosure.

FIG. 5 is a schematic structural diagram of a target detection model according to an embodiment of this disclosure.

FIG. 6 is a flowchart of still another biometric recognition method according to an embodiment of this disclosure.

FIG. 7 is a flowchart of determining a second recognition region according to an embodiment of this disclosure.

FIG. 8 is a flowchart of training a target detection model according to an embodiment of this disclosure.

FIG. 9 is a schematic diagram of a sample image according to an embodiment of this disclosure.

FIG. 10 is a flowchart of model packaging according to an embodiment of this disclosure.

FIG. 11 is a flowchart of still another biometric recognition method according to an embodiment of this disclosure.

FIG. 12 is a schematic diagram of a weight of a 1^{st} image according to an embodiment of this disclosure.

FIG. 13 is a flowchart of still another biometric recognition method according to an embodiment of this disclosure.

FIG. 14 is a flowchart of still another biometric recognition method according to an embodiment of this disclosure.

FIG. 15 is a schematic structural diagram of a biometric recognition apparatus according to an embodiment of this disclosure.

FIG. 16 is a schematic structural diagram of another biometric recognition apparatus according to an embodiment of this disclosure.

FIG. 17 is a schematic structural diagram of a terminal according to an embodiment of this disclosure.

FIG. 18 is a schematic structural diagram of a server according to an embodiment of this disclosure.

### DETAILED DESCRIPTION

To describe the objectives, technical solutions, and advantages of embodiments of this disclosure, the following further describes the implementations of this disclosure in further detail with reference to the accompanying drawings.

Descriptions of terms in this disclosure are provided as examples only and are not intended to limit the scope of the disclosure.

The terms “first”, “second”, “third”, “fourth”, and the like used in this disclosure may be used to describe various concepts in this disclosure. However, unless otherwise specified, the concepts are not limited by the terms. The terms are merely used to describe the associated concept or technology. For example, without departing from the scope of this disclosure, a first characteristic may be referred to as a second characteristic, and similarly, the second characteristic may be referred to as the first characteristic.

In the terms “at least one”, “a plurality of”, “each”, and “any one” used in this disclosure, “at least one” includes one, two, or more, “a plurality of” includes two or more, “each” refers to each of a plurality of corresponding items, and “any one” refers to any one of a plurality of items. For example, a plurality of pixels includes three pixels, “each” indicates each of the three pixels, and “any one” indicates any one of the three pixels, which may be the first pixel, the second pixel, or the third pixel. As used herein, “at least one of A, B, or C” is intended to mean any one or more of the listed elements, including A alone, B alone, C alone, A and B, A and C, B and C, or A, B, and C together. Similarly, “one of A or B” includes A alone, B alone, or both A and B.

In some aspects, a biometric recognition method provided in this disclosure can be performed by a computer device. In an embodiment, the computer device is a terminal or a server. In an embodiment, the server is an independent physical server, a server cluster or a distributed system that includes a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In an embodiment, the terminal is a smartphone, a tablet computer, a notebook computer, a desktop computer, a smart speaker, a smartwatch, a smart voice interaction device, a smart home appliance, an in-vehicle terminal, or the like, but is not limited thereto.

In some embodiments, the computer program involved in one or more embodiments of this disclosure may be deployed in one computer device for execution, or deployed in a plurality of computer devices at one location for execution, or distributed in a plurality of computer devices at a plurality of locations and connected via a communication network. The plurality of computer devices at the plurality of locations and connected by the communication network may form a blockchain system.

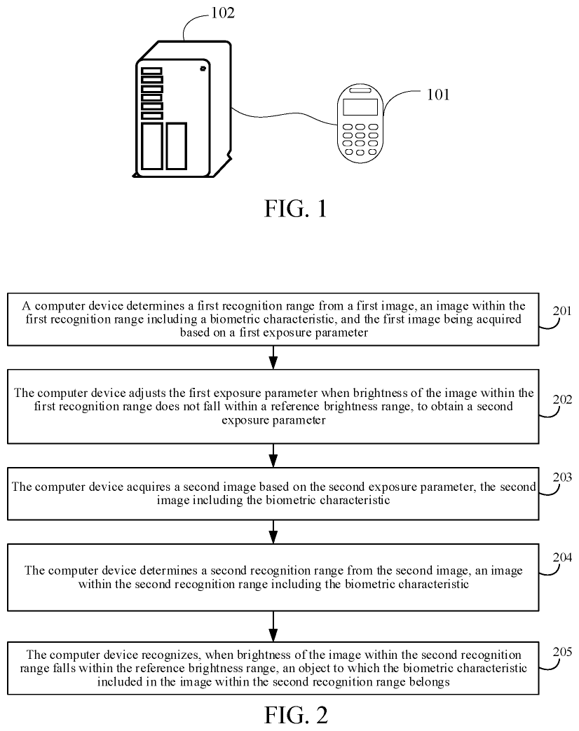

In some embodiments, the computer device is provided as a server. FIG. 1 is a schematic diagram of an implementation environment according to an embodiment of this disclosure. With reference to FIG. 1, the implementation environment includes a terminal 101 and a server 102. The terminal 101 is connected to the server 102 by a wireless or wired network.

The terminal 101 is configured to acquire an image, and transmit the acquired image to the server 102 through a network connection to the server 102. The server 102 is configured to receive the image transmitted by the terminal 101 and process the image, to facilitate recognition on a biometric characteristic included in the image.

In some embodiments, an application whose service is provided by the server 102 is installed on the terminal 101, and the terminal 101 can implement functions such as data transmission and message interaction by using the application. In an embodiment, the application is an application in an operating system of the terminal 101, or an application provided by a third party. For example, the application is any application, having a biometric recognition function. In some aspects, the application can also have other functions such as a review function, a shopping function, a navigation function, and a gaming function.

The terminal 101 is configured to log in to an application based on an account and transmit an acquired image to the server 102 by using the application. The server 102 is configured to receive the image transmitted by the terminal 101 and process the image, to facilitate recognition on a biometric characteristic included in the image.

FIG. 2 is a flowchart of a biometric recognition method according to an embodiment of this disclosure. The method is performed by a computer device. As shown in FIG. 2, the method includes operation 201 to operation 205 as follows:

201: The computer device determines a first recognition region from a first image, an image within the first recognition region including a biometric characteristic, and the first image being acquired based on a first exposure parameter. For example, a first image is acquired based on a first exposure parameter, and a first recognition region in the first image is determined, the first recognition region including a biometric characteristic.

In at least one aspect of this disclosure, in response to a biometric recognition instruction, an image including a biometric characteristic is acquired, so that recognition can be subsequently performed on the image including the biometric characteristic. Considering that content other than the biometric characteristic in the image affects accuracy of biometric recognition, and brightness of a local image including the biometric characteristic affects definition of the biometric characteristic, and further affects accuracy of biometric recognition, the first recognition region is determined from the acquired image to determine a position of the biometric characteristic in the first image. It is detected whether a brightness level of the image within the first recognition region falls within a reference brightness range, to detect whether the local image including the biometric characteristic is sufficiently clear. When the local image including the biometric characteristic is not sufficiently clear, an exposure parameter is adjusted, to help acquire a next image by using the adjusted exposure parameter. In this way, a local image including the biometric characteristic in the acquired next image is clearer. When the local image including the biometric characteristic is sufficiently clear, biometric recognition is performed on the local image including the biometric characteristic to recognize an object to which the biometric characteristic belongs, thereby helping to improve accuracy and a success rate of biometric recognition.

The biometric characteristic refers to a basic attribute or feature possessed by a living creature, and different living creatures may have different biometric characteristics. A type of the biometric characteristic is not limited in this disclosure. For example, the type of the biometric characteristic may include, but is not limited to, a fingerprint characteristic, an iris characteristic, a facial characteristic, a palm print characteristic, and the like.

The biometric characteristic may be located at any position in the first image. For example, the biometric characteristic is located at an upper-left corner of the first image, or is located at an upper-right corner of the first image. The first recognition region is a range of the biometric characteristic recognized from the first image, and the image within the first recognition region includes the complete biometric characteristic. The first recognition region can be a range of any shape. For example, the first recognition region is a circular range or a square range. In at least one aspect of this disclosure, determining the first recognition region from the first image refers to determining a position of the first recognition region in the first image. For example, the position may be represented by using coordinates. That is, a position of the biometric characteristic is determined from the first image. An exposure parameter is used for acquiring an image, and the exposure parameter includes an aperture, a shutter speed, photosensibility, or the like. The first exposure parameter refers to an exposure parameter used when the first image is acquired.

For example, the computer device performs image acquisition on a capture region by using an image acquisition device on which the first exposure parameter is configured, to obtain the first image. The image acquisition device may be any apparatus having an image acquisition function. In some embodiments, the image acquisition function may also be referred to as a camera acquisition device, an image sensor, or the like.

For example, the computer device acquires the first image in response to the biometric recognition instruction. A manner in which the computer device obtains the biometric recognition instruction is not limited in this disclosure. For example, the computer device has a biometric recognition control, and the computer device obtains a biometric recognition instruction in response to a trigger operation on a biometric recognition control. For example, the computer device obtains a biometric recognition instruction in response to detecting that a biometric characteristic is in a capture region. For example, the computer device obtains a biometric recognition instruction in response to detecting an execution request for a target operation. The execution request for a target operation is configured to request execution of the target operation. The target operation is an operation whose execution needs to depend on a biometric recognition result.

A type of the computer device is not limited in this disclosure, and may be related to various biometric recognition scenarios. For example, if the biometric recognition scenario is an attendance-recording scenario, the computer device may be an attendance-recording device. If the biometric recognition scenario is a payment scenario, the computer device may be a payment device, a scanning device, or the like.

202. The computer device adjusts the first exposure parameter when a brightness level of the image within the first recognition region does not fall within a reference brightness range, to obtain a second exposure parameter. For example, a second exposure parameter is obtained by processing circuitry, based on adjusting the first exposure parameter when a brightness level of the first recognition region does not fall within a reference brightness range.

In at least one aspect of this disclosure, the reference brightness range is any brightness range. That the brightness level of the image within the first recognition region falls within the reference brightness range indicates that the local image including the biometric characteristic is sufficiently clear. That the brightness level of the image within the first recognition region does not fall within the reference brightness range indicates that the local image including the biometric characteristic is not sufficiently clear. In addition, considering that the exposure parameter affects brightness of the acquired image, that is, whether the image is clear is related to the exposure parameter used during image acquisition, when the first recognition region is determined from the first image, it is detected whether the brightness of the image within the first recognition region falls within the reference brightness range, and when the brightness level of the image within the first recognition region does not fall within the reference brightness range, it is determined that the local image including the biometric characteristic is not sufficiently clear. Therefore, the first exposure parameter used for acquiring the first image is adjusted to obtain a new exposure parameter, so that a next image can be acquired by using the new exposure parameter, thereby improving definition of a local image including the biometric characteristic in the acquired next image.

In at least one embodiment, a manner of determining the reference brightness range may be: obtaining a historical image on which biometric recognition has been performed and a recognition result of the historical image, the recognition result of the historical image including a recognition success and a recognition failure, the recognition success being configured to indicate that a process of performing biometric recognition on the historical image succeeds, and the recognition failure being configured to indicate that the process of performing biometric recognition on the historical image fails; and determining, in the historical image, a candidate image whose recognition result indicates a recognition success, and using a brightness range of the candidate image as the reference brightness range.

The image within the first recognition region is equivalent to a local image including the biometric characteristic in the first image. The second exposure parameter is different from the first exposure parameter. For example, the first exposure parameter is different from the second exposure parameter in one or more of an aperture, a shutter speed, or photosensibility.

203. The computer device acquires a second image based on the second exposure parameter, the second image including the biometric characteristic. For example, a second image is acquired based on the second exposure parameter, the second image including the biometric characteristic.

In at least one aspect of this disclosure, when the second exposure parameter is obtained, an image is acquired by using the second exposure parameter, to obtain the second image, so that biometric recognition can be subsequently performed by using the second image.

204. The computer device determines a second recognition region from the second image, an image within the second recognition region including the biometric characteristic. In some aspects, motion information indicating a change of a position of the biometric characteristic in the second image relative to the first image is determined by the processing circuitry. In some examples, a second recognition region in the second image is determined based on the motion information, the second recognition region including the biometric characteristic.

For example, a process in which the computer device determines the second recognition region in the second image includes: determining a third recognition region from the second image based on a position of the first recognition region in the first image, a position of the third recognition region in the second image being the same as the position of the first recognition region in the first image; and adjusting the position of the third recognition region in the second image, to obtain the second recognition region.

In at least one aspect of this disclosure, the first image and the second image are acquired in response to one biometric recognition instruction, and the second image is an image acquired after the first image. Relative to the first image, the position of the biometric characteristic in the second image may change. However, considering that a time interval between acquisition of the first image and acquisition of the second image is short, the position of the biometric characteristic in the second image does not greatly change compared with the position of the biometric characteristic in the first image. Therefore, the third recognition region is determined from the second image by using the position of the first recognition region in the first image, so that the second recognition region can be determined from the second image as soon as possible by using the third recognition region. In this way, an image within the second recognition region includes the biometric characteristic.

A shape of the third recognition region is the same as that of the first recognition region, and the third recognition region is equivalent to a region obtained by mapping the first recognition region to the second image. For example, a size of the first image is the same as a size of the second image, a size of the third recognition region is the same as a size of the first recognition region, and the position of the third recognition region in the second image is the same as the position of the first recognition region in the first image. For example, the position of the first recognition region in the first image may be represented by using coordinates of the first recognition region in the first image. For example, the first recognition region is a rectangular range or a square range, and the position of the first recognition region in the first image may be represented by using coordinates of four corners of the rectangular range or the square range.

The position of the first recognition region in the first image may alternatively be represented by using another type of information. For example, the first recognition region is a circular range, and the position of the first recognition region in the first image may be represented by using coordinates of a center of the circular range and a radius of the circular range. For another example, the first recognition region is a square range, and the position of the first recognition region in the first image may be represented by using coordinates of a center of the square range and a side length of the square range. For another example, the first recognition region is a rectangular range, and the position of the first recognition region in the first image may be represented by using coordinates of an upper-left corner of the rectangular range and a length and a width of the rectangular range.

In at least one aspect of this disclosure, because the third recognition region is determined based on the first recognition region in the first image, considering that the position of the biometric characteristic may change when the first image and the second image are acquired, and as a result, the position of the biometric characteristic in the first image is different from the position of the biometric characteristic in the second image, the position of the third recognition region in the second image is adjusted, and the adjusted recognition region is the second recognition region determined from the second image, so that the image within the second recognition region includes the biometric characteristic, thereby improving accuracy of the obtained second recognition region. In at least one aspect of this disclosure, determining the second recognition region from the second image refers to determining a position of the second recognition region in the second image, that is, determining a position of the biometric characteristic in the second image.

205. The computer device recognizes, when a brightness level of the image within the second recognition region falls within the reference brightness range, an object to which the biometric characteristic included in the image within the second recognition region belongs. For example, when a brightness level of the second recognition region falls within the reference brightness range, an object associated with the biometric characteristic included in the second recognition region is recognized.

For example, when the brightness level of the image within the second recognition region falls within the reference brightness range, the computer device performs biometric recognition on the image within the second recognition region, to recognize the object to which the biometric characteristic included in the image within the second recognition region belongs. Biometric recognition refers to performing recognition on a biometric

characteristic included in an image, to recognize an object to which the biometric characteristic belongs. For example, the computer device has reference images corresponding to a plurality of objects stored. A reference image corresponding to an object includes a biometric characteristic of the object. When the brightness level of the image within the second recognition region falls within the reference brightness range, the image within the second recognition region is compared with the plurality of reference images, to determine which reference image includes a biometric characteristic the same as the biometric characteristic included in the image within the second recognition region. When the biometric characteristic included in the image within the second recognition region is the same as a biometric characteristic included in any reference image, the computer device determines that the biometric characteristic included in the image within the second recognition region is a biometric characteristic of an object corresponding to the reference image.

In at least one aspect of this disclosure, the image within the second recognition region is equivalent to a local image including the biometric characteristic in the second image. That the brightness level of the image within the second recognition region falls within the reference brightness range indicates that the local image including the biometric characteristic in the second image is sufficiently clear. Therefore, biometric recognition can be performed on the local image including the biometric characteristic in the second image, to recognize a biometric characteristic of which object the biometric characteristic is, thereby improving accuracy of biometric recognition.

In the solutions provided in one or more embodiments of this disclosure, during biometric recognition, a first recognition region is determined from an acquired first image, to determine a position of a biometric characteristic in the first image. It is detected whether a brightness level of an image within the first recognition region is sufficient, to determine whether the biometric characteristic in the first image is sufficiently clear. When the brightness level of the image within the first recognition region does not fall within a reference brightness range, it is determined that the biometric characteristic in the first image is not sufficiently clear, an exposure parameter is adjusted, to acquire a next image (that is, a second image) by using the adjusted exposure parameter, so that definition of the biometric characteristic in the acquired next image is improved. When brightness of an image (that is, an image including the biometric characteristic) within a second recognition region in the second image falls within the reference brightness range, the biometric characteristic in the second image is sufficiently clear. In this case, biometric recognition is performed on the image within the second recognition region to recognize a biometric characteristic of which object the biometric characteristic is, so that a recognition error or a recognition failure caused by an unclear biometric characteristic in the image can be reduced, thereby improving accuracy and a success rate of biometric recognition.

In addition, considering that the time interval between acquisition of the first image and acquisition of the second image is short, compared with the position of the biometric characteristic in the first image, the position of the biometric characteristic in the second image does not greatly change. Therefore, the third recognition region may be determined from the second image by using the position of the first recognition region in the first image, so that the second recognition region can be determined from the second image as soon as possible by using the third recognition region, thereby improving efficiency of determining the second recognition region while enhancing the chance that the image within the second recognition region includes the biometric characteristic.

Based on the non-limiting example shown in FIG. 2, in at least one aspect of this disclosure, the first recognition region can be determined by using multi-scale characteristics of the first image in a multi-rescaling manner. For a specific process, reference may be made to the following embodiment.

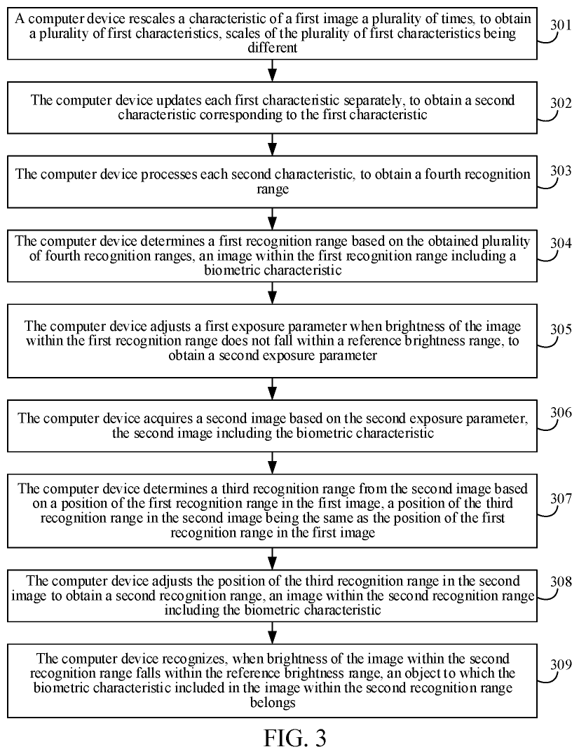

FIG. 3 is a flowchart of another biometric recognition method according to an embodiment of this disclosure. The method is performed by a computer device. As shown in FIG. 3, the method includes operation 301 to operation 309.

301. The computer device rescales a feature of the first image a plurality of times, to obtain a plurality of first features, scales of the plurality of first features being different. For example, a feature of the first image is rescaled based on a plurality of different scales, to obtain a plurality of first features.

In at least one aspect of this disclosure, considering that characteristics at different scales of the first image may express different meanings, multi-scale characteristics of the first image are obtained, to enrich characteristic expressions of the first image, to subsequently help detect the position of the biometric characteristic in the first image by using the multi-scale characteristics of the first image, thereby improving accuracy of the subsequently determined first recognition region.

A feature of the first image is used to represent the first image, and the feature of the first image can be a characteristic of any type. For example, the feature of the first image is a color histogram characteristic, a histogram of oriented gradient characteristic, or the like. Multiple-rescaling refers to rescaling a characteristic a plurality of times, to obtain characteristics at a plurality of different scales, and characteristics obtained during the plurality of times of rescaling have different scales. For example, dimension reduction is performed on the feature of the first image a plurality of times, and a characteristic obtained through each time of dimension reduction is a first feature. Performing dimension reduction on the feature of the first image a plurality of times is equivalent to rescaling the feature of the first image a plurality of times. For another example, dimension expansion is performed on the feature of the first image a plurality of times, and a characteristic obtained through each time of dimension expansion is a first feature. Performing dimension expansion on the feature of the first image a plurality of times is equivalent to rescaling the feature of the first image a plurality of times. Dimension reduction is used for reducing a scale of a characteristic, and dimension expansion is used for increasing a scale of a characteristic. In some embodiments, the scale of the characteristic may also be understood as a dimension of the characteristic.

In a possible implementation, the first image is an image acquired in response to the biometric recognition instruction, and the first image is acquired based on the first exposure parameter.

The biometric recognition instruction instructs acquisition of an image for biometric recognition. The first image may be a 1^{st} acquired image, or may not be a 1^{st} acquired image.

In at least one aspect of this disclosure, when the first image is a 1^{st} image acquired in response to the biometric recognition instruction, the first exposure parameter is a default exposure parameter. When the first image is an n^{th} image acquired in response to the biometric recognition instruction, the first exposure parameter is obtained by adjusting an exposure parameter used for acquiring an (n−1)^{th} image, n being an integer greater than 1.

In at least one aspect of this disclosure, an image is acquired in response to a biometric recognition instruction, and further, recognition is performed on a biometric characteristic in the acquired image. Moreover, after the image is acquired, a recognition region is determined from the acquired image, to determine a position of the biometric characteristic in the acquired image. It is detected whether a brightness level of an image within the recognition region falls within a reference brightness range. When the brightness level of the image within the recognition region does not fall within the reference brightness range, an exposure parameter is adjusted, to help acquire a next image by using the adjusted exposure parameter, and then, detection is performed again. The foregoing process is repeated until a brightness level of an image within a recognition region determined from a currently acquired image falls within the reference brightness range, and then, biometric recognition is performed on the image within the current recognition region.

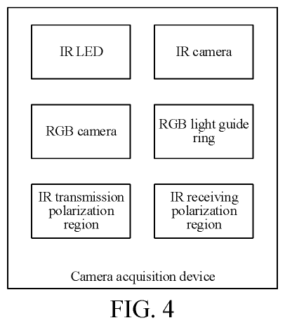

In an embodiment, the computer device acquires an image of a capture region through a camera acquisition device, to obtain a first image. The camera acquisition device is configured to acquire an image. As shown in FIG. 4, the camera acquisition device includes an infrared radiation (IR) transmission polarization region, an IR receiving polarization region, a red green blue (RGB) light guide ring, an IR camera, an RGB camera, and an IR light-emitting diode (LED). For example, through the camera acquisition device, it can be monitored whether a biometric characteristic exists in the capture region, and when it is detected that a biometric characteristic exists in the capture region, the capture region is photographed to obtain an image.

In a possible implementation, operation 301 includes: performing dimension reduction on a feature of the first image, to obtain a 1^{st} first feature, and performing dimension reduction on the i^{th} first feature, to obtain an (i+1)^{th} first feature, i being an integer greater than 0 and less than n. n is a quantity of first features, n is an integer greater than 1, and a value of n may be set according to experience, or may be flexibly adjusted according to an application scenario. This is not limited in this disclosure.

In at least one aspect of this disclosure, dimension reduction is performed the feature of the first image a plurality of times, to obtain first features at a plurality of scales, so that all the first features at the plurality of scales can represent the first image, to help ensure accuracy of the obtained plurality of first features, thereby improving accuracy of the determined first recognition region, and improving accuracy of biometric recognition.

In a possible implementation, operation 301 includes: performing dimension expansion on a feature of the first image, to obtain a 1^{st} first feature, and performing dimension expansion on the i^{th} first feature, to obtain an (i+1)^{th} first feature, i being an integer greater than 0 and less than n.

Dimension expansion is performed the feature of the first image a plurality of times, to obtain first features at a plurality of scales, so that all the first features at the plurality of scales can represent the first image, to improve accuracy of the obtained plurality of first features, thereby improving accuracy of the determined first recognition region, and improving accuracy of biometric recognition.

In a possible implementation, operation 301 includes: partitioning the first image, to obtain a plurality of image blocks; classifying each image block, to obtain a category to which the image block belongs; forming, based on the categories to which the plurality of image blocks belong, a regional image by using image blocks belonging to a target category, the target category indicating that the image block includes the biometric characteristic; and rescaling a feature of the regional image a plurality of times, to obtain the plurality of first features. In some examples, the first image is partitioned into a plurality of image blocks, the plurality of image blocks is classified into one or more different categories, and a regional image is formed based on a subset of the plurality of image blocks that is classified into a target category, the target category indicating that the subset of the plurality of image blocks includes the biometric characteristic. In some examples, the feature of the first image that is included in the regional image is rescaled based on the plurality of different scales, to obtain the plurality of first features.

In at least one aspect of this disclosure, considering that the first image may further include other content in addition to the biometric characteristic, by partitioning the first image to classify image blocks included in the first image, a local image including the biometric characteristic is extracted from the first image, to further extract a feature of the local image, and use the feature of the local image as a feature of the first image, to help subsequently perform biometric recognition by using the feature of the local image, to reduce impact of the other content in the first image, so that the extracted first feature can more accurately represent the biometric characteristic, thereby improving accuracy of the determined first recognition region and improving accuracy of biometric recognition.

A size of the image block can be any size, for example, the size of the image block is 5×5. Sizes of the plurality of image blocks may be the same or may be different. In the plurality of image blocks, any image block may include a complete biometric characteristic, any image block may include a part of a biometric characteristic, or any image block may not include a biometric characteristic. A category to which the image block belongs indicates whether the image block includes a biometric characteristic. An image block belonging to a target category includes a biometric characteristic. The image block belonging to the target category may include a part of a biometric characteristic, or may include a complete biometric characteristic. The regional image is a local image including a biometric characteristic in the first image. A feature of the regional image is configured to represent the regional image, and the feature of the regional image can be a characteristic of any type. For example, the feature of the regional image is a color histogram characteristic, a histogram of oriented gradient characteristic, or the like.

In an embodiment, all of the plurality of image blocks are classified, to obtain a weight of each image block, the weight indicating a possibility that the image block includes a biometric characteristic. When the weight of the image block is not less than a threshold, the image block is determined to belong to a target category. When the weight of the image block is less than the threshold, the image block is determined to belong to a different category.

The category to which the image block belongs includes the target category or one or more different categories. The weight of the image block is in a positive correlation with the possibility that the image block includes a biometric characteristic. That is, a larger weight of the image block indicates a higher possibility that the image block includes a biometric characteristic. For example, a value range of the weight of the image block is [0, 1], and the weight of the image block being 0 represents that the image block does not include a biometric characteristic. The weight of the image block being 1 indicates that the image block includes a biometric characteristic. The threshold is any value, for example, the threshold is 0.8.

For example, if the weight of the image block is 0.9, the threshold is 0.8, and the weight of the image block is not less than the threshold, the image block belongs to the target category. For another example, if the weight of the image block is 0.7, the threshold is 0.8, and the weight of the image block is less than the threshold, the image block belongs to a different category.

In an embodiment, a process of determining the weight of the image block includes: performing feature extraction on the image block, to obtain a feature of the image block; and performing feature transformation on the feature of the image block, to obtain a weight of the image block.

In at least one aspect of this disclosure, by extracting a feature of the image block and adopting feature transformation, for example, performing convolutional processing on the feature of the image block, the feature of the image block is transformed into a value to represent a weight of the image block, so that the weight of the image block can indicate a possibility that the image block includes the biometric characteristic, thereby improving accuracy of the weight, and improving the accuracy of the category to which the image block belongs. This is beneficial to improving reliability of the first feature, thereby further improving accuracy of the determined first recognition region, and improving accuracy of biometric recognition.

In an embodiment, a process of obtaining the feature of the regional image includes: partitioning the regional image, to obtain a plurality of first image blocks; and performing feature extraction on each first image blocks, to obtain a feature of the first image block; and concatenating the characteristics of the plurality of first image blocks, to obtain the feature of the regional image.

For example, a feature of each first image block is a histogram of oriented gradient characteristic, and characteristics of a plurality of first image blocks are concatenated end to end into a vector as the feature of the regional image.

In an embodiment, a process of obtaining the regional image includes: partitioning the first image by using an image recognition model, to obtain a plurality of image blocks; classifying each image block, to obtain a category to which the image block belongs; and forming, based on the categories to which the plurality of image blocks belong, the regional image by using image blocks belonging to a target category.

For example, the image recognition model is any network model. For example, the image recognition model is a lightweight convolutional neural network. The image recognition model can partition an inputted image and determine a weight of each image block, to further output, based on the weights, the regional image including the biometric characteristic. For example, by partitioning the inputted image, the image recognition model obtains characteristics of a plurality of image blocks, and makes the characteristics of the plurality of image blocks pass through an attention layer to obtain a weight of each image block, to further output, based on the weights, the regional image including the biometric characteristic.

In a possible implementation, before the feature of the first image is obtained, the first image can also be denoised, to eliminate a noisy pixel in the first image, that is, filter out the noisy pixel in the first image. For example, a process of filtering out the noisy pixel in the first image includes: processing the noisy pixel in the first image in a median filtering manner.

Median filtering is a non-linear smoothing technology, in which a pixel value of each pixel is set to a median of pixel values of all pixels within a neighborhood window of the pixel.

In at least one aspect of this disclosure, the first image is denoised in a median filtering manner, to adjust a pixel value of a noisy pixel in the first image, to improve accuracy of the first image after the filtering.

In an embodiment, pixel values of pixels in the first image are adjusted in a traversing manner based on a specified window.

For example, a width and a height of the first image are determined, and a width and a height of the window are determined. Based on the window, pixel values of pixels within the window are sorted by starting traversing from an upper-left corner of the first image, to obtain a pixel value queue. A pixel value (that is, a median of pixel values of pixels within the window) in the pixel value queue at a middle position of the queue is used as a pixel value of a pixel corresponding to a center of the window. Then, the window is moved based on a stride, and the pixel values of the pixels within the window are sorted again in the foregoing manner, to update the pixel value of the pixel corresponding to the center of the window. By analogy, updating of pixel values of pixels in the first image is completed.

In an embodiment, a noisy pixel in the first image is determined based on the pixel values of the pixels in the first image. Based on the window, a plurality of reference pixels are determined by using the noisy pixel as a center. The plurality of reference pixels are pixels included in a window centered on the noisy pixel. Pixel values of the plurality of reference pixels are sorted, to obtain a pixel value queue. A pixel value in the pixel value queue at a middle position of the queue is used as a pixel value of the noisy pixel.

In an embodiment, a process of determining the noisy pixel includes: traversing the first image based on a reference window; during the traversing, determining a mean pixel value of pixels within the reference window; and determining, when an absolute value of a difference between a pixel value of any pixel within the reference window and the mean pixel value is greater than a difference threshold, the pixel as a noisy pixel. The difference threshold may be set according to experience, or may be flexibly adjusted according to an application scenario. This is not limited in this disclosure. A size of the reference window may be set according to experience, or may be flexibly adjusted according to an application scenario. This is not limited in this disclosure.

In at least one embodiment, for a case in which the first image is denoised before the feature of the first image is obtained, a manner of obtaining the feature of the first image is: obtaining the denoised first image; and performing feature extraction on the denoised first image, to obtain the feature of the first image.

302: The computer device updates each first feature separately, to obtain a second feature corresponding to the first feature. For example, each one of the plurality of first features is updated, to obtain a respective one of a plurality of second features.

In at least one aspect of this disclosure, by using a plurality of first features, each first feature is separately updated, so that each second feature obtained through the update is fused with another first feature, to enhance correlation between characteristics at different scales, to improve accuracy of the obtained second feature.

In a possible implementation, operation 302 includes: rescaling a fifth feature, to obtain a rescaled fifth feature, a scale of the rescaled fifth feature being the same as a scale of a sixth feature; and fusing the rescaled fifth feature with the sixth feature, to obtain a second feature corresponding to the sixth feature. The sixth feature is any first feature in the plurality of first features, and the fifth feature is a characteristic in the plurality of first features other than the sixth feature.

In at least one aspect of this disclosure, because scales of the plurality of first features are different, each first feature is updated by first performing rescaling and then performing fusion, to help ensure accuracy of the obtained second feature.

303. The computer device processes each second feature, to obtain a fourth recognition region. For example, each one of the plurality of second features is processed, to obtain a respective one of candidate recognition regions of a plurality of candidate recognition regions.

In at least one aspect of this disclosure, each second feature can represent the first image. Therefore, by processing each second feature, the position of the biometric characteristic in the first image can be predicted based on a second feature at each scale, to obtain a plurality of fourth recognition regions.

In at least one aspect of this disclosure, determining the fourth recognition region from the first image refers to determining a position of the fourth recognition region in the first image, that is, determining a position of the biometric characteristic in the first image. Obtaining a plurality of fourth recognition regions refers to determining, in the first image, a plurality of positions at which the biometric characteristic may be located.

In a possible implementation, operation 303 includes: performing biometric detection on each second feature, to obtain the fourth recognition region. The biometric detection corresponds to detecting, based on the second feature, whether the first image includes a biometric characteristic, and predicting a position of the biometric characteristic in the first image when it is detected that the first image includes the biometric characteristic. The position, predicted through the biometric detection, of the biometric characteristic in the first image is the fourth recognition region.

In at least one aspect of this disclosure, by using a characteristic of an image, a position of a biometric characteristic in the image is detected in a biometric detection manner, to obtain a recognition region, so that the recognition region indicates the position of the biometric characteristic, thereby improving accuracy of the recognition region.

Operation 301 to operation 303 can be performed by using a target detection model. The target detection model is configured to determine a position of a biometric characteristic in an image by using an inputted image feature. The target detection model can be any neural network model. For example, the target detection model includes a convolutional or feedforward neural network.

In a possible implementation, the target detection model includes a backbone submodel, a neck submodel, and a head submodel.

The neck submodel is configured to perform the foregoing operation 302, to update characteristics at a plurality of scales. The head submodel is configured to perform operation 303, to output a position (that is, the fourth recognition region) of the biometric characteristic in the image based on a characteristic at each scale. The backbone submodel is configured to rescale the inputted image feature a plurality of times. The backbone submodel can be any network model. For example, the backbone submodel is a neural network model including a convolutional layer and a gate recurrent unit (GRU) layer. The convolutional layer is a two-dimensional (2D) convolutional layer. For example, the backbone submodel includes a 2D convolutional layer, a non-linear activation function, Dropout (a network layer), a pooling layer, a fully-connected layer, and the like. For another example, the backbone submodel is a neural network model including a convolutional layer and a long short-term memory (LSTM) layer, and the convolutional layer is a 3D convolutional layer. For another example, the backbone submodel includes a 2D convolutional layer and a largest convolutional network.

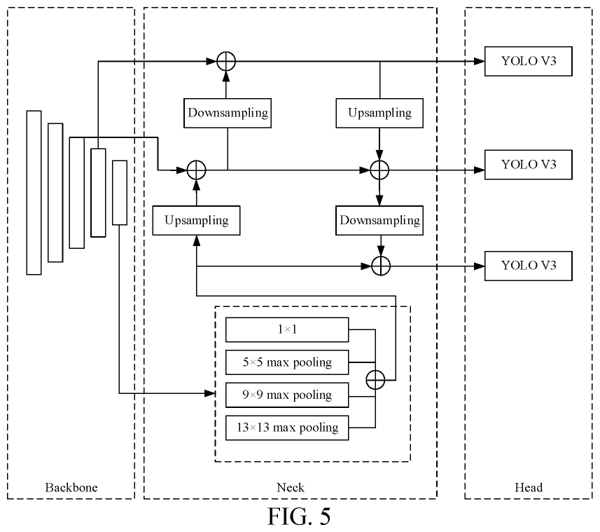

For example, a structure of the target detection model is shown in FIG. 5. The backbone submodel includes a plurality of convolutional layers, configured to rescale the inputted image feature a plurality of times. The neck submodel includes an upsampling layer, a downsampling layer, and a pooling layer. A characteristic at each scale can be updated based on characteristics at a plurality of scales by using the upsampling layer, the downsampling layer, and the pooling layer. The head submodel includes a plurality of detection modules. Different detection modules are configured to perform detection on characteristics at different scales to output a position of the biometric characteristic. For example, the detection module is You Only Look Once version 3 (YOLO V3).

304: The computer device determines a first recognition region based on the obtained plurality of fourth recognition regions, an image within the first recognition region including the biometric characteristic. For example, the first recognition region is determined based on the plurality of candidate recognition regions.

In at least one aspect of this disclosure, considering that characteristics at different scales of the first image may express different meanings, multi-scale characteristics of the first image are obtained, to enrich characteristic expressions of the first image. By using the multi-scale characteristics of the first image, a position that the biometric characteristic may be located is determined from the first image. To be specific, a plurality of fourth recognition regions are determined, so that an accurate position of the biometric characteristic can be determined based on the plurality of fourth recognition regions, that is, the first recognition region can be determined, thereby improving accuracy of the determined first recognition region.

In a possible implementation, operation 304 includes: determining, based on a confidence of each fourth recognition region, a fourth recognition region having a highest confidence in the plurality of fourth recognition regions as the first recognition region, the confidence of each fourth recognition region indicating a possibility that an image within the fourth recognition region includes the biometric characteristic.

The confidence of the fourth recognition region is in a positive correlation with a possibility that an image within the fourth recognition region includes a biometric characteristic. That is, a higher confidence of the fourth recognition region indicates a higher possibility that an image within the fourth recognition region includes a biometric characteristic. For example, a value range of the confidence of the fourth recognition region is [0, 1], and the confidence of the fourth recognition region being 0 represents that the image within the fourth recognition region does not include a biometric characteristic. The confidence of the fourth recognition region being 1 represents that the image within the fourth recognition region includes a biometric characteristic.

In at least one aspect of this disclosure, when each fourth recognition region is obtained, a confidence of the fourth recognition region can also be obtained. The confidence can reflect a possibility that an image within the fourth recognition region includes a biometric characteristic. Therefore, a fourth recognition region having a highest confidence is determined as the first recognition region, to help ensure that an image within the determined first recognition region includes the biometric characteristic, thereby improving accuracy of the first recognition region, and improving accuracy of biometric recognition.

In an embodiment, a process of obtaining the confidence of the fourth recognition region includes: performing biometric detection on the second feature, to obtain a fourth recognition region and a confidence of the fourth recognition region. That is, in addition to detecting, based on the second feature, whether the first image includes the biometric characteristic and predicting the fourth recognition region when it is detected that the first image includes the biometric characteristic, the biometric detection further corresponds to outputting a confidence of the predicted fourth recognition region.

305. The computer device adjusts the first exposure parameter when a brightness level of the image within the first recognition region does not fall within a reference brightness range, to obtain a second exposure parameter.

In a possible implementation, a process of determining the brightness of the image within the first recognition region includes: determining the brightness of the image within the first recognition region based on a pixel value of a pixel in the image within the first recognition region.

In at least one aspect of this disclosure, because the pixel value of the pixel in the image within the first recognition region can reflect brightness of pixels, the brightness level of the image within the first recognition region is determined based on the pixel value of the pixel in the image within the first recognition region, to improve accuracy of the determined brightness.

In an embodiment, if a pixel value of each pixel is represented in a red green blue (RGB) form, a process of determining the brightness of the image within the first recognition region includes: for each pixel in the image within the first recognition region, weighting an R value, a G value, and a B value of the pixel, to obtain brightness of the pixel, and determining average brightness of pixels in the image within the first recognition region as the brightness of the image within the first recognition region.

In at least one aspect of this disclosure, a pixel value of each pixel is represented by colors of three channels: red, green, and blue. Color values of the three channels of red, green, and blue of each pixel are weighted to obtain brightness of the pixel, to determine the brightness of the image within the first recognition region based on brightness of pixels in the image within the first recognition region.

In a possible implementation, a manner of adjusting the first exposure parameter includes: increasing the first exposure parameter when the brightness level of the image within the first recognition region is less than a minimum value in the reference brightness range, to obtain the second exposure parameter; or decreasing the first exposure parameter when the brightness level of the image within the first recognition region is greater than a maximum value in the reference brightness range, to obtain the second exposure parameter.

In at least one aspect of this disclosure, when the brightness level of the image within the first recognition region does not fall within the reference brightness range, the first exposure parameter is adjusted based on a magnitude relationship between the brightness of the image within the first recognition region and a brightness value within the reference brightness range, so that when an image is subsequently acquired based on the obtained second exposure parameter, a brightness level of an image within a range in which a biometric characteristic in the acquired image is located falls within the reference brightness range as much as possible, to improve the accuracy of the determined second exposure parameter. After the second image is acquired based on such a second exposure parameter, a probability that a brightness level of an image within a second recognition region in the second image falls within the reference brightness range is higher, thereby facilitating improving a possibility of directly performing biometric recognition based on the image within the second recognition region, and improving efficiency of biometric recognition.

306. The computer device acquires a second image based on the second exposure parameter, the second image including the biometric characteristic.

In a possible implementation, if the computer device includes an image sensor, operation 306 includes: adjusting an exposure parameter of the image sensor to a second exposure parameter, and acquiring an image by using the adjusted image sensor, to obtain a second image.

In at least one aspect of this disclosure, the image sensor in the computer device is configured to acquire an image. The computer device acquires a screen in a capture region as an image by using the image sensor. Therefore, the computer device first adjusts an exposure parameter of the image sensor to the second exposure parameter, to acquire an image based on the second exposure parameter by using the adjusted image sensor, to obtain the second image.

307: The computer device determines a third recognition region from the second image based on a position of the first recognition region in the first image, a position of the third recognition region in the second image being the same as the position of the first recognition region in the first image.

In a possible implementation, operation 307 includes: determining a position parameter of the first recognition region in the first image, and determining a third recognition region from the second image based on the position parameter of the first recognition region in the first image, a position parameter of the third recognition region in the second image being the same as the position parameter of the first recognition region in the first image.

For example, the position parameter of the first recognition region in the first image indicates a position of the first recognition region in the first image, and the position parameter includes coordinates. The position parameter of the first recognition region in the first image can be represented in any form. For example, the first recognition region is a square range, and the position parameter of the first recognition region in the first image includes coordinates of a center of and a side length of the first recognition region. Alternatively, the position parameter of the first recognition region in the first image includes coordinates of four corners. For another example, the first recognition region is a circular region, and the position parameter of the first recognition region in the first image includes coordinates of a center of and a radius of the first recognition region.

In at least one aspect of this disclosure, a size of the first image is the same as a size of the second image. By determining the position parameter of the first recognition region in the first image, a third recognition region can be determined from the second image based on the position parameter of the first recognition region in the first image, to aim for the result that the position of the third recognition region in the second image is the same as the position of the first recognition region in the first image, and improve accuracy of the determined third recognition region.

308: The computer device adjusts the position of the third recognition region in the second image to obtain a second recognition region, an image within the second recognition region including the biometric characteristic.

In a possible implementation, operation 308 includes: determining, for each pixel within the third recognition region, a probability corresponding to the pixel, the probability corresponding to the pixel being a probability that an image within a reference recognition region centered on the pixel includes the biometric characteristic, a size of the reference recognition region being the same as a size of the third recognition region; and adjusting the position of the third recognition region in the second image based on the probabilities corresponding to the pixels within the third recognition region, to obtain the second recognition region.

A plurality of probabilities may be determined. Each probability corresponds to one pixel within the third recognition region. A probability corresponding to any pixel is configured to indicate a possibility that an image within a reference recognition region centered on the pixel includes the biometric characteristic. A probability corresponding to any pixel is in a positive correlation with a possibility that an image within a reference recognition region centered on the pixel includes the biometric characteristic. That is, a higher probability corresponding to any pixel indicates a higher possibility that an image within a reference recognition region centered on the pixel includes the biometric characteristic. The reference recognition region is a recognition region whose size is the same as a size of the third recognition region.

In at least one aspect of this disclosure, for each pixel within the third recognition region, a probability corresponding to the pixel is determined, to determine a possibility that an image within the reference recognition region centered on the pixel includes the biometric characteristic. Therefore, the position of the third recognition region in the second image is adjusted based on the determined probability, so that the image within the second recognition region obtained through adjustment includes the biometric characteristic, to improve accuracy of the obtained second recognition region, thereby improving accuracy of the biometric recognition.

In an embodiment, a process of determining the second recognition region includes: determining a target pixel with a highest probability in the pixels within the third recognition region; and adjusting the position of the third recognition region in the second image to a position centered on the target pixel, to obtain the second recognition region, a size of the third recognition region being the same as a size of the second recognition region.

In at least one aspect of this disclosure, a higher probability corresponding to any pixel indicates a higher possibility that an image within a reference recognition region centered on the pixel includes the biometric characteristic. Therefore, a highest probability is determined from the plurality of determined probabilities, a pixel corresponding to the highest probability is determined as a target pixel, and further, the third recognition region is moved, so that the moved recognition region is centered on the target pixel, to help ensure that an image within the obtained second recognition region includes the biometric characteristic, thereby improving accuracy of the obtained second recognition region and accuracy of biometric recognition.

In at least one aspect of this disclosure is described by using an example in which a position of the third recognition region is adjusted once. In another embodiment, a new recognition region can still be determined based on the target pixel in the foregoing manner. Further, for each pixel within the new recognition region, a probability corresponding to the pixel within the new recognition region is determined, and a next target pixel is determined based on the currently determined probability, so that a next recognition region is determined by using the next target pixel as a center. When a distance between the currently determined target pixel and a previous target pixel is less than a first threshold, or when a currently determined highest probability (that is, a probability corresponding to the currently determined target pixel) is greater than a second threshold, the currently determined recognition region is determined as the second recognition region. The first threshold and a second threshold may be set according to experience, or may be flexibly adjusted according to an application scenario. This is not limited in this disclosure.

In an embodiment, a process of determining the probability includes: determining a pixel characteristic of each pixel within the third recognition region; for a first pixel within the third recognition region, determining a distance between a pixel characteristic of each second pixel and a pixel characteristic of the first pixel; and determining an average of a plurality of distances as the probability corresponding to the first pixel, the probability corresponding to the first pixel being a probability that an image within the reference recognition region centered on the first pixel includes the biometric characteristic.

The first pixel is any pixel within the third recognition region, and the second pixel is a pixel other than the first pixel within the reference recognition region centered on the first pixel. A pixel characteristic of a pixel can be represented in any form. For example, the pixel characteristic of the pixel is a color histogram characteristic of the pixel.

In at least one aspect of this disclosure, by using a mean shift method, a probability corresponding to each pixel within the third recognition region can be determined, that is, a probability that an image within a reference recognition region centered on each pixel within the third recognition region includes the biometric characteristic is determined.

In at least one aspect of this disclosure, the second recognition region in the second image is determined by using an optical flow method. Considering that during recognition of the biometric characteristic, a difference between positions of the biometric characteristic in two acquired adjacent images is small, the third recognition region is determined from the second image with reference to the first recognition region in the first image, and the second recognition region is further determined in a pixel clustering manner, to improve accuracy of the determined second recognition region.

In an embodiment, a process of determining the target pixel includes: determining color histogram characteristics of pixels within the third recognition region; determining, by using kernel density estimation, a probability distribution of the pixels based on the color histogram characteristics of the pixels within the third recognition region; and determining a pixel having a highest probability density in the probability distribution as the target pixel.

In a possible implementation, operation 308 includes: determining an adjustment distance and an adjustment direction based on a position of a first key point in the first image and a position of a second key point in the second image, the first key point and the second key point being a same key point of the biometric characteristic; and adjusting a position of the third recognition region in the second image based on the adjustment distance and the adjustment direction, to obtain the second recognition region. For example, an adjustment distance and an adjustment direction may also be referred to as a movement distance and a movement direction of the biometric characteristic. The movement distance and the movement direction of the biometric characteristic refer to a movement distance and a movement direction of the biometric characteristic in the second image relative to the first image. A process of adjusting the position of the third recognition region in the second image based on the adjustment distance and the adjustment direction may be a process of moving the third recognition region based on the movement distance and the movement direction of the biometric characteristic.

A first key point is a key point of the biometric characteristic in the first image, a second key point is a key point of the biometric characteristic in the second image, and the first key point and the second key point are a same key point of the biometric characteristic. For example, the first key point is a center point of the biometric characteristic in the first image and the second key point is a center point of the biometric characteristic in the second image. The first key point is any key point. For example, the first key point is a center point of the biometric characteristic or an edge point of the biometric characteristic.

In at least one aspect of this disclosure, relative to the first image, a position of the biometric characteristic in the second image may change, and a key point of the biometric characteristic also changes. Therefore, when a region of the biometric characteristic in the first image is determined, the key point of the biometric characteristic in the first image and the key point of the biometric characteristic in the second image are recognized, to determine, based on the positions of the key point of the biometric characteristic in the first image and the key point of the biometric characteristic in the second image, a movement distance and a movement direction of the biometric characteristic in the second image relative to the first image, and further move, based on the movement distance and the movement direction, a third recognition region obtained through mapping, to change a position of the third recognition region to obtain the second recognition region, to help ensure that an image within the obtained second recognition region includes the biometric characteristic, thereby improving accuracy of the obtained second recognition region and accuracy of biometric recognition.

In an embodiment, a process of determining the first key point includes: performing key point recognition on the image within the first recognition region, to obtain a first key point.

In at least one aspect of this disclosure, by performing key point recognition on the image within the first recognition region, there is no need to perform key point recognition on an image in another region, to help ensure that the first key point can be obtained as soon as possible, thereby improving accuracy and efficiency of obtaining the first key point.

A process of determining the second key point is the same as the foregoing process of determining the first key point, and further details are not described herein again.

In at least one aspect of this disclosure is described by using one first key point and one second key point as an example. In another embodiment, an adjustment distance and an adjustment direction can also be determined based on positions of a plurality of first key points in the first image and positions of a plurality of second key points in the second image. The plurality of first key points and the plurality of second key points are in a one-to-one correspondence, and the first key points and the corresponding second key points are same key points of the biometric characteristic. A position of the third recognition region in the second image is adjusted based on the adjustment distance and the adjustment direction, to obtain the second recognition region.

In a possible implementation, a process of determining the adjustment distance and the adjustment direction based on the plurality of first key points and the plurality of second key points includes: for each first key point, determining a first distance and a first direction based on a position of the first key point and a position of a corresponding second key point, the first direction pointing from the first key point to the second key point; determining an average of the plurality of first distances as the adjustment distance; and determining an average of the plurality of first directions as the adjustment direction.

In at least one aspect of this disclosure, the first direction is represented by an angle, and is equivalent to an angle between a ray pointing from a point corresponding to coordinates of the first key point to a point corresponding to coordinates of the second key point in an XY coordinate system and an X-axis.

In a possible implementation, operation 308 includes: determining an adjustment distance and an adjustment direction based on a position of a first key point in the first image and a position of a second key point in the second image, the first key point and the second key point being a same key point of the biometric characteristic; adjusting a position of the third recognition region in the second image based on the adjustment distance and the adjustment direction, to obtain a fifth recognition region; determining, for each pixel within the fifth recognition region, a probability corresponding to the pixel within the fifth recognition region, the probability corresponding to the pixel being a probability that an image within a reference recognition region centered on the pixel includes the biometric characteristic; and adjusting a position of the fifth recognition region in the second image based on the probabilities corresponding to the pixels within the fifth recognition region, to obtain the second recognition region.

In at least one aspect of this disclosure, relative to the first image, a position of the biometric characteristic in the second image may change, and a key point of the biometric characteristic also changes. In addition, considering a possibility that an image within a reference recognition region centered on any pixel within the recognition region may include the biometric characteristic, when the first recognition region is determined from the first image, the key point of the biometric characteristic in the first image and the key point of the biometric characteristic in the second image are recognized, to determine, based on the positions of the key point of the biometric characteristic in the first image and the key point of the biometric characteristic in the second image, a movement distance and a movement direction of the biometric characteristic in the second image relative to the first image, and further move, based on the movement distance and the movement direction, a third recognition region obtained through mapping, to obtain a fifth recognition region. Then, based on the probabilities of the pixels within the fifth recognition region, the position of the fifth recognition region in the second image is adjusted, so that an image within the second recognition region obtained through adjustment includes the biometric characteristic, thereby improving accuracy of the obtained second recognition region and accuracy of biometric recognition.

309. The computer device recognizes, when a brightness level of the image within the second recognition region falls within the reference brightness range, an object to which the biometric characteristic included in the image within the second recognition region belongs.

For example, when the brightness level of the image within the second recognition region falls within the reference brightness range, the computer device performs biometric recognition on the image within the second recognition region, to recognize the object to which the biometric characteristic included in the image within the second recognition region belongs.

In a possible implementation, a process of performing biometric recognition on the image includes: comparing, when a brightness level of the image within the second recognition region falls within a reference brightness range, the image within the second recognition region with a plurality of reference images, to obtain a similarity between the image within the second recognition region and each of the reference images; and determining object information of a reference image corresponding to a highest similarity as object information matching the image within the second recognition region. The object information matching the image within the second recognition region is configured to represent an object to which the biometric characteristic included in the image within the second recognition region belongs.

In at least one aspect of this disclosure, each reference image includes a biometric characteristic. The plurality of reference images include different biometric characteristics. Each reference image corresponds to one piece of object information. The biometric characteristic included in the reference image is a biometric characteristic of an object represented by the object information. A higher similarity between the image within the second recognition region and any reference image indicates that the biometric characteristic included in the image within the second recognition region is more similar to the biometric characteristic included in the reference image. Therefore, biometric recognition is performed in a similarity determining manner, to improve accuracy of biometric recognition.

In the solutions provided in one or more embodiments of this disclosure, during biometric recognition, a first recognition region is determined from an acquired first image, to determine a position of a biometric characteristic in the first image. It is detected whether a brightness level of an image within the first recognition region is sufficient, to determine whether the biometric characteristic in the first image is sufficiently clear. When the brightness level of the image within the first recognition region does not fall within a reference brightness range, it is determined that the biometric characteristic in the first image is not sufficiently clear, an exposure parameter is adjusted, to acquire a next image (that is, a second image) by using the adjusted exposure parameter, so that definition of the biometric characteristic in the acquired next image is improved. Considering that a time interval between acquisition of the first image and acquisition of the second image is short, compared with the position of the biometric characteristic in the first image, a position of the biometric characteristic in the second image does not greatly change. Therefore, the third recognition region is determined from the second image by using the position of the first recognition region in the first image, so that the second recognition region can be determined from the second image as soon as possible by using the third recognition region, to cause the image within the second recognition region to include the biometric characteristic. When a brightness level of the image within the second recognition region falls within the reference brightness range, the biometric characteristic in the second image is sufficiently clear. In this case, biometric recognition is performed on the image within the second recognition region to recognize a biometric characteristic of which object the biometric characteristic is, so that a recognition error or a recognition failure caused by an unclear biometric characteristic in the image can be reduced, thereby improving accuracy and a success rate of biometric recognition.

FIG. 3 describes an example in which brightness of the image within the first recognition region does not fall within the reference brightness range and brightness of the image within the second recognition region falls within the reference brightness range. In another embodiment, biometric recognition can also be performed on an image within another recognition region.

In a possible implementation, the method further includes: performing biometric recognition on the image within the first recognition region when the brightness level of the image within the first recognition region falls within the reference brightness range. That is, when the brightness level of the image within the first recognition region falls within the reference brightness range, an object to which the biometric characteristic included in the image within the first recognition region belongs is recognized.

In at least one aspect of this disclosure, when the brightness level of the image within the first recognition region falls within the reference brightness range the image within the first recognition region is sufficiently clear, so that biometric recognition can be performed on the biometric characteristic included in the image within the first recognition region. Therefore, when the brightness level of the image within the first recognition region falls within the reference brightness range, biometric recognition is performed on the image within the first recognition region without acquiring another image, to improve efficiency of biometric recognition.

In a possible implementation, the method further includes: adjusting the second exposure parameter when the brightness level of the image within the second recognition region does not fall within the reference brightness range, to obtain a third exposure parameter; and acquiring a next image based on the third exposure parameter, and performing biometric recognition based on the next image.

In at least one aspect of this disclosure, when the brightness level of the image within the second recognition region does not fall within the reference brightness range, the image within the second recognition region is not sufficiently clear. An exposure parameter used for acquiring a current image is adjusted, to capture a next image by using the adjusted exposure parameter, so that a clearer image can be captured, to improve accuracy of subsequent biometric recognition.

For example, in response to a biometric recognition instruction, a 1^{st} image is acquired based on a 1^{st} exposure parameter, a 1^{st} recognition region is determined from the 1^{st} image, and an image within the 1^{st} recognition region includes a biometric characteristic. Biometric recognition is performed on the image within the 1^{st} recognition region in the 1^{st} image when a brightness level of the image within the 1^{st} recognition region falls within a reference brightness range. The 1^{st} exposure parameter is adjusted when the brightness level of the image within the 1^{st} recognition region does not fall within the reference brightness range, to obtain a 2^{nd} exposure parameter. A 2^{nd} image is acquired based on the 2^{nd} exposure parameter. A 2^{nd} recognition region is determined from the 2^{nd} image, an image within the 2^{nd} recognition region including the biometric characteristic. Biometric recognition is performed on the image within the 2^{nd} recognition region when a brightness level of the image within the 2^{nd} recognition region falls within a reference brightness range. The 2^{nd} exposure parameter is adjusted when the brightness level of the image within the 2^{nd} recognition region does not fall within the reference brightness range, to obtain a 3^{rd} exposure parameter, so that a next image is acquired based on the 3^{rd} exposure parameter. The foregoing process is repeated, to cause a brightness level of an image within a currently determined recognition region to fall within the reference brightness range, to further perform biometric recognition on the image within the currently determined recognition region.

FIG. 3 describes an example in which the first recognition region is determined by using the feature of the first image. In another embodiment, operations 301 to 304 do not need to be performed, and the first recognition region is determined from the first image in another manner.

In a possible implementation, when the first image is not a 1^{st} image acquired in response to the biometric recognition instruction, a seventh recognition region is determined from the first image based on a position of a sixth recognition region in a third image. The position of the sixth recognition region in the third image is the same as a position of the seventh recognition region in the first image. An image within the sixth recognition region includes the biometric characteristic. The third image is an image previous to the first image. The position of the seventh recognition region in the first image is adjusted, to obtain the first recognition region.

Principles of the foregoing process of determining the first recognition region are the same as those of the foregoing operations 307 and 308, and further details are not described herein again.

In a possible implementation, the process of determining the first recognition region includes performing key point detection on the first image, to obtain a plurality of target key points in the first image; and determining the first recognition region from the first image based on relative positional relationships between the plurality of target key points and the biometric characteristic and positions of the plurality of target key points in the first image.

The target key point is a key point of any type. For example, the target key point is a finger key point, and the biometric characteristic is a characteristic of a palm region (that is, a palm print characteristic). In this case, in an image including a hand, a relative positional relationship between the finger and the palm region keeps unchanged regardless of where the palm region is located in the image. The relative positional relationships indicate relationships between positions of the plurality of target key points and a position of the biometric characteristic. For example, the relative positional relationships indicate that the biometric characteristic is located below the plurality of target key points, or indicate that the biometric characteristic is located in the middle of the plurality of target key points.

In at least one aspect of this disclosure, there are relative positional relationships between the biometric characteristic and the plurality of target key points. In an acquired image, regardless of where the biometric characteristic is located in the image, the relative positional relationships between the biometric characteristic and the plurality of target key points remain unchanged. Therefore, key point detection is performed on the first image to detect a plurality of target key points having relative positional relationships with the biometric characteristic, and then the first recognition region is determined from the first image based on positions of the plurality of target key points in the first image and the relative positional relationships between the plurality of target key points and the biometric characteristic. The first recognition region can reflect a position of the biometric characteristic. The accuracy of the obtained first recognition region is thereby improved, thereby improving accuracy of biometric recognition.

Based on the non-limiting embodiments shown in FIG. 2 and FIG. 3, in at least one aspect of this disclosure, the second recognition region can also be determined in a manner of comparing the first image with the second image. For a specific process, reference may be made to the following embodiment.

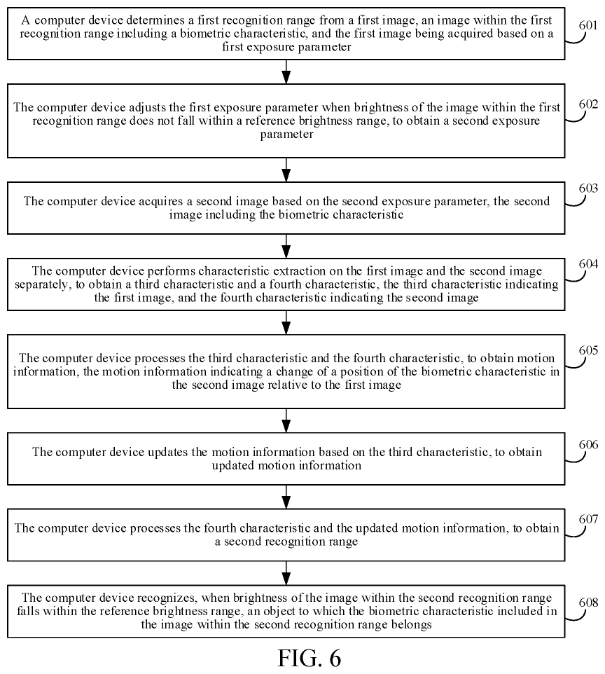

FIG. 6 is a flowchart of still another biometric recognition method according to an embodiment of this disclosure. The method is performed by a computer device. As shown in FIG. 6, the method includes operation 601 to operation 608:

601. The computer device determines a first recognition region from a first image, an image within the first recognition region including a biometric characteristic, and the first image being acquired based on a first exposure parameter.

602. The computer device adjusts the first exposure parameter when a brightness level of the image within the first recognition region does not fall within a reference brightness range, to obtain a second exposure parameter.

603. The computer device acquires a second image based on the second exposure parameter, the second image including the biometric characteristic.

Principles of operations 601 to 603 are the same as those of the foregoing operations 201 to 203, and further details are not described herein again.

604. The computer device performs feature extraction on the first image and the second image separately, to obtain a third feature and a fourth feature, the third feature indicating the first image, and the fourth feature indicating the second image.

For example, the third feature and the fourth feature can both be represented in any form. For example, a representation form of the third feature and the fourth feature may be a color histogram characteristic, a histogram of oriented gradient characteristic, or the like.

In a possible implementation, a manner of obtaining the third feature includes: partitioning the first image, to obtain a plurality of image blocks; performing feature extraction on each image block, to obtain a characteristic of each image block; and concatenating the characteristics of the plurality of image blocks, to obtain the characteristic (that is, the third feature) of the first image.

For example, the feature of the image block is a characteristic of any type. For example, the feature of the image block is a histogram of oriented gradient characteristic. Histogram of oriented gradient characteristics of the plurality of image blocks in the first image are combined end to end into a vector, to obtain the feature of the first image.

A process of obtaining the fourth feature is the same as the process of obtaining the third feature, and details are not described herein again.

605. The computer device processes the third feature and the fourth feature, to obtain motion information, the motion information indicating a change of a position of the biometric characteristic in the second image relative to the first image.

In at least one aspect of this disclosure, the third feature is configured to represent the first image, and the fourth feature is configured to represent the second image. That is, the third feature can represent a position of the biometric characteristic in the first image, and the fourth feature can represent a position of the biometric characteristic in the second image. By processing the third feature and the fourth feature, the first image can be compared with the second image, to determine a change of the position of the biometric characteristic in the second image relative to the first image.

For example, the motion information may be represented in any form. For example, the motion information is represented in a form of a probabilistic graph.

606. The computer device updates the motion information based on the third feature, to obtain updated motion information.

In at least one aspect of this disclosure, the motion information is updated based on the third feature, so that the updated motion information can better reflect a change of the position of the biometric characteristic in the second image relative to the first image, to help subsequently determine whether to determine the position of the biometric characteristic in the second image by using the first recognition region in the first image.

607. The computer device processes the fourth feature and the updated motion information, to obtain a second recognition region.

In at least one aspect of this disclosure, the third feature can represent a position of the biometric characteristic in the first image, and the fourth feature can represent a position of the biometric characteristic in the second image. By processing the third feature and the fourth feature, the first image can be compared with the second image, to determine a change of the position of the biometric characteristic in the second image relative to the first image. The motion information is updated based on the third feature, so that the updated motion information can better reflect the change of the position of the biometric characteristic in the second image relative to the first image. Moreover, the fourth feature can represent content of the second image. Therefore, fourth feature and the updated motion information are processed to obtain the position of the biometric characteristic in the second image, to improve accuracy of the obtained second recognition region, thereby improving accuracy of biometric recognition.

In a possible implementation, operations 604 to 607 are performed by using a target detection model.

As shown in FIG. 7, convolution is performed on the third feature and the fourth feature by using the target detection model, to obtain motion information. The motion information can be represented by a probabilistic graph. Convolution is performed on the third feature and a motion probabilistic graph, to obtain updated motion information. The updated motion information includes a first label or a second label. The first label indicates that a change of the position of the biometric characteristic in the second image relative to the first image is excessively large. Subsequently, the second recognition region is determined with reference to the first label and the feature of the second image. The second label indicates that a change of the position of the biometric characteristic in the second image relative to the first image is not large. The second recognition region in the second image can be determined based on the first recognition region in the first image. When the updated motion information is the first label, convolution is performed on the first label and the fourth feature, to obtain the second recognition region.

In an embodiment, a process of processing the fourth feature and the updated motion information includes: fusing the fourth feature and the updated motion information to obtain a fused feature; rescaling the fused feature a plurality of times, to obtain a plurality of seventh features, scales of the plurality of seventh features being different; updating each seventh characteristic separately based on the plurality of seventh features, to obtain an eighth feature corresponding to the seventh characteristic; processing each eighth feature to obtain an eighth recognition region; and determining the second recognition region based on the obtained plurality of eighth recognition regions. Principles of the foregoing process of determining the second recognition region are the same as those of the foregoing operations 301 to 304, and further details are not described herein again.

608. The computer device recognizes, when a brightness level of the image within the second recognition region falls within the reference brightness range, an object to which the biometric characteristic included in the image within the second recognition region belongs.

Operation 608 is similar to operation 309. Details are not described herein again.

In the solutions provided in one or more embodiments of this disclosure, during biometric recognition, a first recognition region is determined from an acquired first image, to determine a position of a biometric characteristic in the first image. It is detected whether a brightness level of an image within the first recognition region is sufficient, to determine whether the biometric characteristic in the first image is sufficiently clear. When the brightness level of the image within the first recognition region does not fall within a reference brightness range, it is determined that the biometric characteristic in the first image is not sufficiently clear, an exposure parameter is adjusted, to acquire a next image (that is, a second image) by using the adjusted exposure parameter, so that definition of the biometric characteristic in the acquired next image is improved. Considering that a time interval between acquisition of the first image and acquisition of the second image is short, compared with the position of the biometric characteristic in the first image, a position of the biometric characteristic in the second image does not greatly change. Therefore, the third recognition region is determined from the second image by using the position of the first recognition region in the first image, so that the second recognition region can be determined from the second image as soon as possible by using the third recognition region, to cause the image within the second recognition region to include the biometric characteristic. When a brightness level of the image within the second recognition region falls within the reference brightness range, the biometric characteristic in the second image is sufficiently clear. In this case, biometric recognition is performed on the image within the second recognition region to recognize a biometric characteristic of which object the biometric characteristic is, so that a recognition error or a recognition failure caused by an unclear biometric characteristic in the image can be reduced, thereby improving accuracy and a success rate of biometric recognition.

The foregoing manner of determining the second recognition region from the second image is a non-limiting example, and this disclosure is not limited thereto.

In some embodiments, a manner of determining the second recognition region from the second image may be rescaling a feature of the second image a plurality of times, to obtain a plurality of ninth features, scales of the plurality of ninth features being different; updating each ninth characteristic separately based on the plurality of ninth features, to obtain a tenth feature corresponding to the ninth characteristic; processing each tenth feature to obtain a ninth recognition region; and determining the second recognition region based on the obtained plurality of ninth recognition regions. Principles of such a process of determining the second recognition region are the same as those of the process of determining the first recognition region based on operation 301 to operation 304, and details are not described herein again.

In some embodiments, a manner of determining the second recognition region from the second image may be: performing key point detection on the second image, to obtain a plurality of target key points in the second image; and determining the second recognition region from the second image based on relative positional relationships between the plurality of target key points and the biometric characteristic and positions of the plurality of target key points in the second image. Principles of such a process of determining the second recognition region are the same as those of the foregoing described process of determining the first recognition region by performing key point detection on the first image, and details are not described herein again.

Based on the non-limiting embodiment shown in FIG. 6, before the biometric recognition method is implemented by using the target detection model, the target detection model also needs to be trained. A process of training the target detection model is shown in FIG. 8. The method includes: image acquisition, image annotation, image preprocessing, model construction, model weight initialization, model training, and model parameter adjustment.
(1) Image acquisition and image annotation: A plurality of sample images are acquired, and a sample label of each sample image is determined. The sample label indicates a type of a biometric characteristic included in the sample image. A sample recognition region is determined from the sample image. An image within the sample recognition region includes the biometric characteristic.

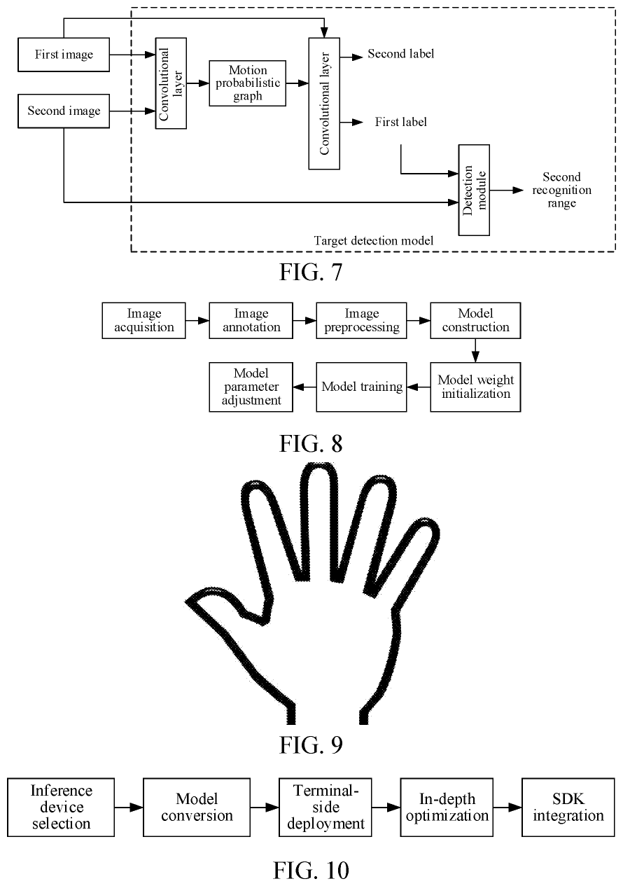

In at least one aspect of this disclosure, the biometric characteristic includes a plurality of types. For example, when the biometric characteristic is a characteristic of the left hand or a characteristic of the right hand, the label includes a first sample label or a second sample label. The first sample label indicates a biometric characteristic of the left hand, and the second sample label indicates a biometric characteristic of the right hand. For example, the sample image is shown in FIG. 9.

The sample images include a positive sample image or a negative sample image. The positive sample image is an image obtained by photographing a biometric characteristic, and the negative sample image is an image that does not include a biometric characteristic or an image that includes an unclear biometric characteristic.

In a possible implementation, when the sample images are obtained, the sample images are further cleaned, and a process of cleaning the sample images includes: filtering out, from the plurality of sample images, a repeated sample image, a sample image including an incomplete biometric characteristic, a sample image with excessively low definition, and the like.

In at least one aspect of this disclosure, the sample images are cleaned, to improve quality of the sample images, thereby improving quality of subsequent model training.
(2) Image preprocessing: A sample image is denoised in a median filtering manner, to eliminate a noisy pixel from the sample image. Subsequently, the sample image is divided into a plurality of image blocks in a partitioning manner, and a category of each image block is determined, and image blocks belonging to a target category are formed into a regional image, the regional image including the biometric characteristic. A histogram of oriented gradient characteristic of each image block in the regional image is extracted in a manner of extracting a histogram of oriented gradient characteristic. Histogram of oriented gradient characteristics of the plurality of image blocks in the regional image are combined end to end into a one-dimensional vector, and the one-dimensional vector is used as a feature of the sample image.

In a possible implementation, a histogram of oriented gradient characteristic of an image block is determined by using the following functions:

$$\begin{matrix}M ( x , y ) = \sqrt{{I}_{x}^{2} + {I}_{y}^{2}} \\ θ ( x , y ) = {tan}^{- 1} \frac{{I}_{x}}{{I}_{y}} \\ θ ( x , y ) ∈ [ 0 , 360 ° ) or θ ( x , y ) ∈ [ 0 , 180 ° )\end{matrix}$$

where x is configured to represent a horizontal coordinate of a pixel in the image block, y is configured to represent a vertical coordinate of the pixel in the image block, Iₓ is configured to represent a gradient value of the pixel in a horizontal direction, I_{y} is configured to represent a gradient value of the pixel in a vertical direction, M(x,y) is configured to represent an amplitude value of a gradient, and θ(x,y) is configured to represent a direction of the gradient. The amplitude value of the gradient and the direction of the gradient are a histogram of oriented gradient characteristic.

In at least one aspect of this disclosure, the histogram of oriented gradient feature of the image block is determined according to the foregoing functions by using a Sobel (edge detection) algorithm with a 60×60 resolution.
(3) Model construction and model weight initialization: An initialized target detection model is constructed, and a weight of the target detection model is initialized.
(4) Model training and model parameter adjustment: A feature of the sample image is processed by using the target detection model, to obtain a predicted recognition region. A model parameter of the target detection model is adjusted based on the sample recognition region and the predicted recognition region, to train the target detection model.

In a possible implementation, a loss value is determined based on the sample recognition region and the predicted recognition region in an Intersection over Union (IOU) or mean Average Precision Intersection over Union (mAPIOU) manner. The loss value indicates a difference between the sample recognition region and the predicted recognition region. The target detection model is trained based on the loss value.

After training of the target detection model is completed according to the foregoing embodiment, the target detection model can be packaged into a software development kit (SDK). As shown in FIG. 10, a process of packaging the model includes: selecting an inference device, performing model transformation on the target detection model, performing terminal-side deployment, performing in-depth optimization on the model, and obtaining SDK integration.

The inference device includes a neural network processing unit (NPU) or a central processing unit (CPU). A data type includes INT8 (a data type) or INT16 (a data type). A manner of the terminal-side deployment includes a hardware abstraction layer, platform abstraction, or model parsing, and a manner of the in-depth optimization includes operator optimization, scheduling optimization, or memory optimization. For example, an NPU is selected as the inference device, selected data types are INT8 and INT16, deployment is performed by adopting a hardware abstraction layer, and a scheduling optimization is adopted, to generate an SDK.

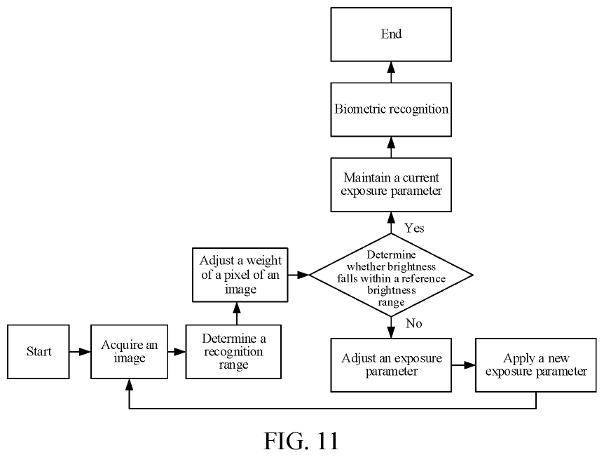

Based on one or more embodiments shown in FIG. 2 to FIG. 9, an embodiment of this disclosure further provides a flowchart of a biometric recognition method. As shown in FIG. 11, the method includes the following operation 1 to operation 6:

Operation 1. Acquire a 1^{st} image based on a default exposure parameter in response to a biometric recognition instruction.

Operation 2. Perform detection on the 1^{st} image by using a target detection model, to obtain a 1^{st} recognition region, an image in the 1^{st} recognition region including a biometric characteristic.

Operation 3. Set a weight of a pixel within the 1^{st} recognition region in the 1^{st} image to 255, and set weights of remaining pixels in the 1^{st} image to 0; and determine brightness of the 1^{st} image according to a pixel value of the pixel in the 1^{st} image and a weight of the pixel. Because a weight of a pixel outside the 1^{st} recognition region in the 1^{st} image is 0, brightness of the 1^{st} image is a brightness level of an image within the 1^{st} recognition region.

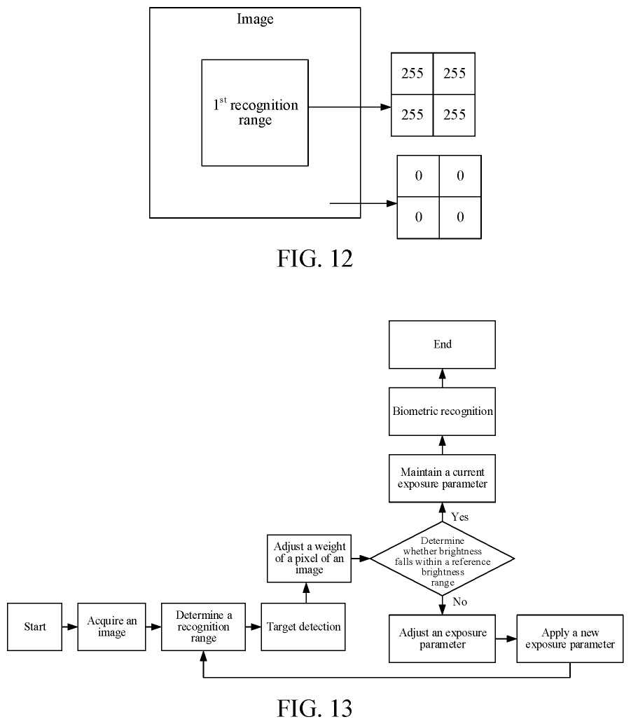

As shown in FIG. 12, the weight of the pixel within the 1^{st} recognition region in the 1^{st} image is set to 255, and weights of pixels at remaining positions are set to 0.

Operation 4. Determine whether a brightness level of the image within the 1 st recognition region falls within a reference brightness range.

Operation 5. Perform biometric recognition on the image within the 1^{st} recognition region when the brightness level of the image within the 1^{st} recognition region falls within the reference brightness range.

In addition, when the brightness level of the image within the 1^{st} recognition region falls within the reference brightness range, it can also be determined that the biometric characteristic in the image acquired based on the default exposure parameter is sufficiently clear, and subsequently, a plurality of images can be acquired based on the default exposure parameter, and a recognition region is determined from each image, thereby performing biometric recognition on images within recognition regions in a plurality of images.

Operation 6. Adjust a current exposure parameter when the brightness level of the image within the 1^{st} recognition region does not fall within the reference brightness range, acquire a next image by using the exposure parameter obtained through adjustment, further determine a next recognition region from the next image according to the foregoing process, determine whether a brightness level of an image within the next recognition region falls within the reference brightness range, and until a brightness level of an image within a currently obtained recognition region in an image falls within the reference brightness range, perform biometric recognition on the image within the currently obtained recognition region.

In addition, when the brightness level of the image within the currently obtained recognition region falls within the reference brightness range, it can also be determined that the biometric characteristic in the image acquired based on the current exposure parameter is sufficiently clear, and subsequently, a plurality of images can be acquired based on the current exposure parameter, and a recognition region is determined from each image, thereby performing biometric recognition on images within recognition regions in a plurality of images.

Based on the non-limiting embodiment shown in FIG. 11, as shown in FIG. 13, in a process of performing biometric recognition in response to a biometric recognition instruction, for images other than the 1^{st} image, an optical flow method is adopted, and a recognition region in a current image can be determined by using a position of a recognition region in a previous image. This process is similar to operations 307 and 308, and details are not described herein again.

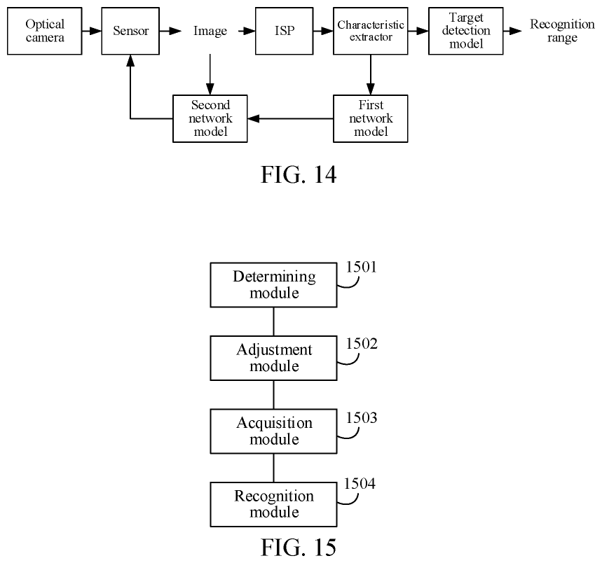

Based on one or more embodiments shown in FIG. 2 to FIG. 13, an embodiment of this disclosure further provides a flowchart of a biometric recognition method. As shown in FIG. 14, the method includes: photographing an environment by using an image sensor in an optical camera, to obtain a 1^{st} image; processing the 1^{st} image by using an image processing module, and obtaining a characteristic of the processed 1^{st} image by using a characteristic extractor; processing the characteristic of the processed 1^{st} image by using a channel compression layer, an average pooling layer, a max pooling layer, a fully-connected layer, and the like in a first network model, to obtain an automatic exposure control parameter; obtaining multi-scale histogram characteristics of the 1^{st} image, determining, with reference to the automatic exposure control parameter, an exposure parameter of the image sensor by using a convolutional layer and a fully-connected layer in a second network model, and adjusting the exposure parameter of the image sensor based on the exposure parameter; and repeating the foregoing process definition of the biometric characteristic in an image acquired based on the current image sensor is sufficient. The environment is photographed by using the current image sensor, to obtain a next image. An example in which a j^{th} image is obtained is used, j being an integer greater than 1. The j^{th} image is processed by using the image processing module. A characteristic of the processed j^{th} image is obtained by using the characteristic extractor. Biometric detection is performed on the characteristic of the processed j^{th} image by using a target detection model, to obtain a recognition region, an image within the recognition region in the j^{th} image including a biometric characteristic.

For example, the image processing module is software image signal processing (SoftISP).

In at least one aspect of this disclosure, automatic exposure is a manner of automatically adjusting an exposure parameter based on brightness of ambient light to aim for the effect that an image may be properly exposed under different lighting conditions. Based on this, a target detection model and a target detection algorithm are introduced to improve accuracy of a photometric algorithm, to aim for the effect that a biometric characteristic in an obtained image may be sufficiently clear, thereby improving accuracy of biometric recognition.

The biometric recognition method provided in at least one aspect of this disclosure can be applied to a plurality of scenarios, for example, applied to a payment scenario or an attendance-recording scenario.

Using an attendance-recording scenario as an example, when it is detected by using an attendance-recording device that there is a biometric characteristic in a capture region, acquisition is performed on the biometric characteristic in the capture region based on a default exposure parameter, to obtain an image including the biometric characteristic. According to the solution provided in at least one aspect of this disclosure, an image having sufficiently high definition and including a biometric characteristic can be acquired, and then the acquired image is compared with a prestored image, to determine object information matching the acquired image, and determine that an object indicated by the object information has completed attendance-recording.

Using a payment scenario as an example, when payment is made for an order, in a case that it is detected by using a scanning device that there is a biometric characteristic in a capture region, acquisition is performed on the biometric characteristic in the capture region based on a default exposure parameter, to obtain an image including the biometric characteristic. According to the solution provided in at least one aspect of this disclosure, an image having sufficiently high definition and including a biometric characteristic can be acquired, and then the acquired image is compared with a prestored image, to determine object information matching the acquired image, and transfer, according to an amount of resources to be paid for the order, the amount of resources from an account of the object information.

FIG. 15 is a schematic structural diagram of a biometric recognition apparatus according to an embodiment of this disclosure. As shown in FIG. 15, the apparatus includes:
a determining module 1501, configured to determine a first recognition region from a first image, an image within the first recognition region including a biometric characteristic, and the first image being acquired based on a first exposure parameter;
an adjustment module 1502, configured to adjust the first exposure parameter when a brightness level of the image within the first recognition region does not fall within a reference brightness range, to obtain a second exposure parameter;
an acquisition module 1503, configured to acquire a second image based on the second exposure parameter, the second image including the biometric characteristic,
the determining module 1501 being further configured to determine a second recognition region from the second image, an image within the second recognition region including the biometric characteristic; and
a recognition module 1504, configured to recognize, when a brightness level of the image within the second recognition region falls within the reference brightness range, an object to which the biometric characteristic included in the image within the second recognition region belongs.

In a possible implementation, the determining module 1501 is configured to rescale a feature of the first image a plurality of times, to obtain a plurality of first features, scales of the plurality of first features being different; update each first feature separately, to obtain a second feature corresponding to the first feature; process each second feature, to obtain a fourth recognition region; and determine the first recognition region based on the obtained plurality of fourth recognition regions.

In another possible implementation, the determining module 1501 is configured to partition the first image, to obtain a plurality of image blocks; classify each image block, to obtain a category to which the image block belongs; form, based on the categories to which the plurality of image blocks belong, a regional image by using image blocks belonging to a target category, the target category indicating that the image block includes the biometric characteristic; and rescale a feature of the regional image a plurality of times, to obtain the plurality of first features.

In another possible implementation, the determining module 1501 is configured to determine, based on a confidence of each fourth recognition region, a fourth recognition region having a highest confidence in the plurality of fourth recognition regions as the first recognition region, the confidence of each fourth recognition region indicating a possibility that an image within the fourth recognition region includes the biometric characteristic.

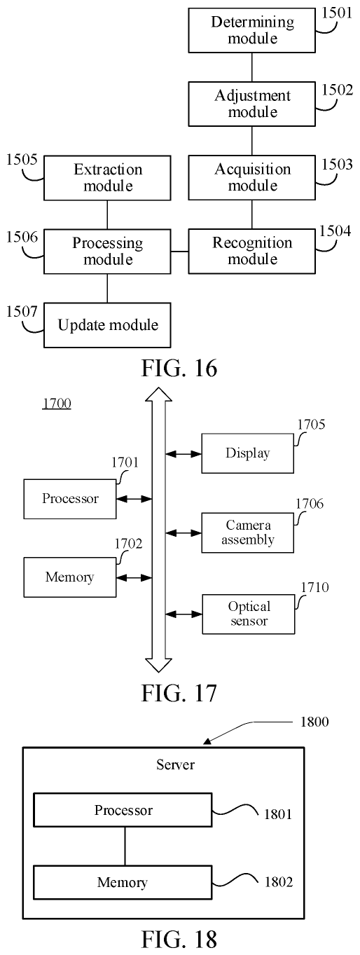

In another possible implementation, as shown in FIG. 16, the apparatus further includes:
an extraction module 1505, configured to perform feature extraction on the first image and the second image separately, to obtain a third feature and a fourth feature, the third feature indicating the first image, and the fourth feature indicating the second image;
a processing module 1506, configured to process the third feature and the fourth feature, to obtain motion information, the motion information indicating a change of a position of the biometric characteristic in the second image relative to the first image; and
an update module 1507, configured to update the motion information based on the third feature, to obtain updated motion information,
the processing module 1506 being further configured to process the fourth feature and the updated motion information, to obtain the second recognition region.

In another possible implementation, the determining module 1501 is configured to determine a third recognition region from the second image based on a position of the first recognition region in the first image, a position of the third recognition region in the second image being the same as the position of the first recognition region in the first image.

The adjustment module 1502 is configured to adjust the position of the third recognition region in the second image, to obtain the second recognition region.

In another possible implementation, the adjustment module 1502 is configured to determine, for each pixel within the third recognition region, a probability corresponding to the pixel, the probability corresponding to the pixel being a probability that an image within a reference recognition region centered on the pixel includes the biometric characteristic, a size of the reference recognition region being the same as a size of the third recognition region; and adjust the position of the third recognition region in the second image based on the probabilities corresponding to the pixels within the third recognition region, to obtain the second recognition region.

In another possible implementation, the adjustment module 1502 is configured to determine a target pixel with a highest probability in the pixels within the third recognition region; and adjust the position of the third recognition region in the second image to a position centered on the target pixel, to obtain the second recognition region.

In another possible implementation, the adjustment module 1502 is configured to determine an adjustment distance and an adjustment direction based on a position of a first key point in the first image and a position of a second key point in the second image, the first key point and the second key point being a same key point of the biometric characteristic; and adjust a position of the third recognition region in the second image based on the adjustment distance and the adjustment direction, to obtain the second recognition region.

In another possible implementation, the determining module 1501 is configured to perform key point detection on the first image, to obtain a plurality of target key points in the first image; and determine the first recognition region from the first image based on relative positional relationships between the plurality of target key points and the biometric characteristic and positions of the plurality of target key points in the first image.

In another possible implementation, the adjustment module 1502 is further configured to adjust the second exposure parameter when the brightness level of the image within the second recognition region does not fall within the reference brightness range, to obtain a third exposure parameter.

The acquisition module 1503 is further configured to acquire a next image based on the third exposure parameter.

The recognition module 1504 is further configured to perform biometric recognition based on the next image.

In another possible implementation, the recognition module 1504 is further configured to: recognize, when the brightness level of the image within the first recognition region falls within the reference brightness range, an object to which the biometric characteristic included in the image within the first recognition region belongs.

In another possible implementation, the adjustment module 1502 is configured to increase the first exposure parameter when the brightness of the image within the first recognition range is less than a minimum value in the reference brightness range, to obtain the second exposure parameter; and decrease the first exposure parameter when the brightness of the image within the first recognition range is greater than a maximum value in the reference brightness range, to obtain the second exposure parameter.

When the biometric recognition apparatus provided in the foregoing embodiments implements the functions of the apparatus, only division of the foregoing functional modules is used as an example for description. During actual application, the foregoing functions may be allocated to and completed by different functional modules according to requirements. In other words, an internal structure of the computer device is divided into different functional modules, to implement all or part of the functions described above. In addition, the biometric recognition apparatus and biometric recognition method embodiments provided in the foregoing embodiments belong to the same conception. For the specific implementation process, reference may be made to the method embodiments, and details are not described herein again.

Modules, submodules, and units described in this disclosure may be implemented by processing circuitry, software executed by a processor, or a combination thereof. The processing circuitry may include, but is not limited to, a central processing unit (CPU), a graphics processing unit (GPU), a field-programmable gate array (FPGA), an application-specific integrated circuit (ASIC), or a neural network processing unit (NPU). When implemented in software, the modules may be stored as instructions in a non-transitory computer-readable storage medium and executed by one or more processors. The relationship between software modules and hardware components is understood to be interchangeable where the functional description permits such exchange.

An embodiment of this disclosure further provides a computer device, the computer device including processing circuitry (e.g., a processor) and a memory, the memory may include a non-transitory computer-readable storage medium having at least one computer program stored therein, the at least one computer program being loaded and executed by the processor, to cause the computer device to implement operations performed in the biometric recognition method in the foregoing embodiments.

In an embodiment, the computer device is provided as a terminal. FIG. 17 is a structural block diagram of a terminal 1700 according to an embodiment of this disclosure. The terminal 1700 includes processing circuitry (e.g., a processor 1701) and a memory 1702.

The processor 1701 may include one or more processing cores, and may be, for example, a 4-core processor or an 8-core processor. The processor 1701 may be implemented by using at least one of the following hardware forms: digital signal processing (DSP), a field-programmable gate array (FPGA), or a programmable logic array (PLA). The processor 1701 may also include a main processor and a coprocessor. The main processor is configured to process data in an active state, also referred to as a central processing unit (CPU). The coprocessor is a low-power processor configured to process data in a standby state. In some embodiments, the processor 1701 may be integrated with a graphics processing unit (GPU). The GPU is configured to render and draw content that needs to be displayed on a display. In some embodiments, the processor 1701 may alternatively include an artificial intelligence (AI) processor. The AI processor is configured to process a computing operation related to machine learning.

The memory 1702 may include one or more computer-readable storage mediums that may be non-transitory. The memory 1702 may further include a high-speed random access memory and a non-volatile memory, for example, one or more disk storage devices or flash storage devices. In some embodiments, the non-transitory computer-readable storage medium in the memory 1702 is configured to store at least one computer program. The at least one computer program is configured to be executed by the processor 1701 to perform the biometric recognition method according to the method embodiments in this disclosure.

In some embodiments, the terminal 1700 may further include: a display 1705, a camera assembly 1706, and an optical sensor 1710.

The display 1705 is configured to display a user interface (UI). The UI may include graphics, text, icons, videos, and any combination thereof. When the display 1705 is a touchscreen, the display 1705 is further capable of collecting touch signals on or above a surface of the display 1705. The touch signal may be inputted to the processor 1701 as a control signal for processing. In this case, the display 1705 may be further configured to provide a virtual button and/or a virtual keyboard that are/is also referred to as a soft button and/or a soft keyboard. In some embodiments, there may be one display 1705 arranged on a front panel of the terminal 1700. In some other embodiments, there may be at least two displays 1705 which are respectively arranged on different surfaces of the terminal 1700 or are folded. In some other embodiments, the display 1705 may be a flexible display, arranged on a curved surface or a folded surface of the terminal 1700. Even, the display 1705 may be further set in a non-rectangular irregular pattern, namely, a special-shaped screen. The display 1705 may be manufactured by using a material such as a liquid crystal display (LCD) or an organic light-emitting diode (OLED).

The camera assembly 1706 is configured to collect images or videos. In an embodiment, the camera assembly 1706 includes a front-facing camera and a rear-facing camera. The front camera is arranged on the front panel of the terminal, and the rear camera is arranged on a back of the terminal. In some embodiments, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera assembly 1706 may further include a flashlight. The flash may be a single color temperature flash, or may be a double color temperature flash. The double color temperature flash refers to a combination of a warm flash and a cold flash, and may be used for light compensation at different color temperatures.

The optical sensor 1710 is configured to collect ambient light intensity. In an embodiment, the processor 1701 may control the display brightness of the display 1705 according to the ambient light intensity acquired by the optical sensor 1710. For example, when the ambient light intensity is high, the display brightness of the display 1705 is increased; and when the ambient light intensity is low, the display brightness of the display 1705 is decreased. In another embodiment, the processor 1701 may further dynamically adjust a camera parameter of the camera assembly 1706 according to the ambient light intensity acquired by the optical sensor 1710.

A person skilled in the art may understand that the structure shown in FIG. 17 constitutes no limitation on the terminal 1700, and the terminal may include more or fewer components than those shown in the figure, or some components may be combined, or a different component deployment may be used.

In an embodiment, the computer device is provided as a server. FIG. 18 is a schematic structural diagram of a server according to an embodiment of this disclosure. A server 1800 may vary considerably depending on configuration or performance, and may include processing circuitry (e.g., one or more central processing units (CPUs) 1801) and one or more memories 1802 (e.g., including one or more non-transitory computer-readable storage media). Each memory 1802 has at least one computer program stored therein. The at least one computer program is loaded and executed by the processor 1801, to implement the biometric recognition method according to the foregoing method embodiments. In some aspects, the server may further have components such as a wired or wireless network interface, a keyboard, and an I/O interface for input and output. The server may further include another component for achieving a device function. Details are not described herein.

An embodiment of this disclosure further provides a non-transitory computer-readable storage medium, having at least one computer program being stored therein, the at least one computer program being loaded and executed by processing circuitry (e.g., a processor), to cause a computer to implement the operations performed in the biometric recognition method according to the foregoing embodiments.

An embodiment of this disclosure further provides a computer program product, including a computer program, the computer program, when executed by processing circuitry (e.g., a processor), causing a computer to implement the operations performed in the biometric recognition method according to the foregoing embodiments.

A person of ordinary skill in the art may understand that all or some of the steps of the foregoing embodiments may be implemented by hardware, or may be implemented by a program instructing related hardware. The program may be stored in a non-transitory computer-readable storage medium. The storage medium may be: a read-only memory, a magnetic disk, or an optical disc.

The above descriptions are merely non-limiting examples of this disclosure, and are not intended to limit the scope of this disclosure. Any modification, equivalent replacement, improvement, or the like made within the principle of this disclosure falls within the scope of this disclosure.

What is claimed is:

1. A biometric recognition method, the method comprising:
acquiring a first image based on a first exposure parameter;
determining a first recognition region in the first image, the first recognition region including a biometric characteristic;
obtaining, by processing circuitry, a second exposure parameter based on adjusting the first exposure parameter when a brightness level of the first recognition region does not fall within a reference brightness range;
acquiring a second image based on the second exposure parameter, the second image including the biometric characteristic;
determining, by the processing circuitry, motion information indicating a change of a position of the biometric characteristic in the second image relative to the first image;
determining a second recognition region in the second image based on the motion information, the second recognition region including the biometric characteristic; and
recognizing, when a brightness level of the second recognition region falls within the reference brightness range, an object associated with the biometric characteristic included in the second recognition region.

2. The method according to claim 1, wherein the determining the first recognition region in the first image comprises:
rescaling a feature of the first image based on a plurality of different scales, to obtain a plurality of first features;
updating each one of the plurality of first features, to obtain a respective one of a plurality of second features;
processing each one of the plurality of second features, to obtain a respective one of candidate recognition regions of a plurality of candidate recognition regions; and
determining the first recognition region based on the plurality of candidate recognition regions.

3. The method according to claim 2, wherein the rescaling the feature of the first image comprises:
partitioning the first image into a plurality of image blocks;
classifying the plurality of image blocks into one or more different categories;
forming a regional image based on a subset of the plurality of image blocks that is classified into a target category, the target category indicating that the subset of the plurality of image blocks includes the biometric characteristic; and
rescaling the feature of the first image that is included in the regional image based on the plurality of different scales, to obtain the plurality of first features.

4. The method according to claim 2, wherein the determining the first recognition region comprises:
obtaining a respective confidence level for each one of the plurality of candidate recognition regions, the confidence level indicating a possibility that an image within the candidate recognition region includes the biometric characteristic; and
determining one of the plurality of candidate recognition regions that has a highest confidence level as the first recognition region.

5. The method according to claim 1, wherein
the determining the motion information includes:
performing feature extraction on the first image and the second image, to obtain a third feature of the first image and a fourth feature of the second image; and
processing the third feature and the fourth feature, to obtain the motion information; and
the determining the second recognition region in the second image includes:
updating the motion information based on the third feature, to obtain updated motion information; and
processing the fourth feature and the updated motion information, to obtain the second recognition region.

6. The method according to claim 1, wherein the determining the second recognition region comprises:
determining a third recognition region from the second image based on a position of the first recognition region in the first image; and
adjusting a position of the third recognition region in the second image, to obtain the second recognition region.

7. The method according to claim 6, wherein the adjusting the position of the third recognition region comprises:
determining, for each pixel within the third recognition region, a probability that an image within a reference recognition region centered on the pixel includes the biometric characteristic, a size of the reference recognition region being same as a size of the third recognition region; and
adjusting the position of the third recognition region in the second image based on the probabilities corresponding to the pixels within the third recognition region, to obtain the second recognition region.

8. The method according to claim 7, wherein the adjusting the position of the third recognition region in the second image based on the probabilities corresponding to the pixels within the third recognition region comprises:
determining a target pixel with a highest probability in the pixels within the third recognition region; and
adjusting the position of the third recognition region in the second image to a position centered on the target pixel, to obtain the second recognition region.

9. The method according to claim 6, wherein the adjusting the position of the third recognition region comprises:
determining an adjustment distance and an adjustment direction based on a position of a first key point in the first image and a position of a second key point in the second image, the first key point and the second key point corresponding to a same key point of the biometric characteristic; and
adjusting a position of the third recognition region in the second image based on the adjustment distance and the adjustment direction, to obtain the second recognition region.

10. The method according to claim 1, wherein the determining a first recognition region in the first image comprises:
performing key point detection on the first image, to obtain a plurality of target key points in the first image; and
determining the first recognition region in the first image based on relative positional relationships between the plurality of target key points and the biometric characteristic and positions of the plurality of target key points in the first image.

11. The method according to claim 1, further comprising:
obtaining a third exposure parameter based on adjusting the second exposure parameter when the brightness level of the second recognition region does not fall within the reference brightness range;
acquiring a next image based on the third exposure parameter; and
performing biometric recognition based on the next image.

12. The method according to claim 1, further comprising:
recognizing, when the brightness level of the first recognition region falls within the reference brightness range, an object associated with the biometric characteristic included in the first recognition region.

13. The method according to claim 1, wherein the obtaining the second exposure parameter comprises:
increasing an exposure level indicated by the first exposure parameter when the brightness of the first recognition region is less than a minimum value in the reference brightness range, to obtain the second exposure parameter; and
decreasing the exposure level indicated by the first exposure parameter when the brightness of the first recognition region is greater than a maximum value in the reference brightness range, to obtain the second exposure parameter.

14. A biometric recognition apparatus, comprising:
processing circuitry configured to:
acquire a first image based on a first exposure parameter;
determine a first recognition region in the first image, the first recognition region including a biometric characteristic;
obtain a second exposure parameter based on adjusting the first exposure parameter when a brightness level of the first recognition region does not fall within a reference brightness range;
acquire a second image based on the second exposure parameter, the second image including the biometric characteristic;
determine motion information indicating a change of a position of the biometric characteristic in the second image relative to the first image;
determine a second recognition region in the second image based on the motion information, the second recognition region including the biometric characteristic; and
recognize, when a brightness level of the second recognition region falls within the reference brightness range, an object associated with the biometric characteristic included in the second recognition region.

15. The apparatus according to claim 14, wherein the processing circuitry is configured to:
rescale a feature of the first image based on a plurality of different scales, to obtain a plurality of first features;
update each one of the plurality of first features, to obtain a respective one of a plurality of second features;
process each one of the plurality of second features, to obtain a respective one of candidate recognition regions of a plurality of candidate recognition regions; and
determine the first recognition region based on the plurality of candidate recognition regions.

16. The apparatus according to claim 14, wherein the processing circuitry is configured to:
perform feature extraction on the first image and the second image, to obtain a third feature of the first image and a fourth feature of the second image; and
process the third feature and the fourth feature, to obtain the motion information;
update the motion information based on the third feature, to obtain updated motion information; and
process the fourth feature and the updated motion information, to obtain the second recognition region.

17. The apparatus according to claim 14, wherein the processing circuitry is configured to:
determine a third recognition region from the second image based on a position of the first recognition region in the first image; and
adjust a position of the third recognition region in the second image, to obtain the second recognition region.

18. The apparatus according to claim 14, wherein the processing circuitry is configured to:
perform key point detection on the first image, to obtain a plurality of target key points in the first image; and
determine the first recognition region in the first image based on relative positional relationships between the plurality of target key points and the biometric characteristic and positions of the plurality of target key points in the first image.

19. The apparatus according to claim 14, wherein the processing circuitry is configured to:
increase an exposure level than that indicated by the first exposure parameter when the brightness of the first recognition region is less than a minimum value in the reference brightness range, to obtain the second exposure parameter; and
decrease the exposure level than that indicated by the first exposure parameter when the brightness of the first recognition region is greater than a maximum value in the reference brightness range, to obtain the second exposure parameter.

20. A non-transitory computer-readable storage medium storing instructions, which when executed by a processor, cause the processor to perform a biometric recognition method, the method comprising:
acquiring a first image based on a first exposure parameter;
determining a first recognition region in the first image, the first recognition region including a biometric characteristic;
obtaining a second exposure parameter based on adjusting the first exposure parameter when a brightness level of the first recognition region does not fall within a reference brightness range;
acquiring a second image based on the second exposure parameter, the second image including the biometric characteristic;
determining motion information indicating a change of a position of the biometric characteristic in the second image relative to the first image;
determining a second recognition region in the second image based on the motion information, the second recognition region including the biometric characteristic; and
recognizing, when a brightness level of the second recognition region falls within the reference brightness range, an object associated with the biometric characteristic included in the second recognition region.
